(19) United States
(12) Patent Application Publication
(10) Pub. No.: US 2021/0147628 A1
(43) Pub. Date: May 20, 2021

(54) HYDROPHILIC POLYIMIDE, MEMBRANES PREPARED THEREFROM, AND USES THEREOF

(71) Applicant: KYOTO UNIVERSITY, Kyoto (JP)

(72) Inventors: Easan SIVANIAH, Kyoto (JP); Behnam GHALEI, Kyoto (JP); Binod Babu SHRESTHA, Kyoto (JP); Daisuke YAMAGUCHI, Kyoto (JP)

(73) Assignee: KYOTO UNIVERSITY, Kyoto (JP)

(21) Appl. No.: 16/687,932

(22) Filed: Nov. 19, 2019

(51) Int. Cl. C08G 73/10; B01D 67/00; B01D 71/64

(52) U.S. Cl. CPC C08G 73/1007; C08G 73/105; B01D 67/0011; B01D 69/12; B01D 71/64; C08G 73/1078; B01D 67/0016

(57) ABSTRACT

The present invention relates to a hydrophilic polyimide including at least one type of building blocks [A-B] and [A-C], and represented by the formula -[A-B]ₙ-[A-C]ₘ— (I), wherein:
the n-bracketed building blocks and the m-bracketed building blocks are randomly distributed over the polyimide chain;
repeat unit A results from a monomer comprising two carboxylic anhydride moieties,
repeat unit B is hydrophilic and results from a first hydrophilic monomer comprising two primary amine moieties and at least one further hydrophilic moiety different from the primary amines, and
repeat unit C is hydrophilic and results from a second hydrophilic monomer comprising two primary amine moieties and at least one further hydrophilic moiety different from the primary amines;
wherein:
n and m represent independently an integer from 0 to about 1000; wherein
n+m is an integer from about 10 to about 1000.

The present invention also relates to a porous membrane comprising the same, a method of producing the hydrophilic polyimide and the porous membrane, a liquid phase separation system comprising the porous membrane, and a liquid phase separation method.

### FIELD OF THE INVENTION

The present invention relates to hydrophilic polyimides including at least one type of building blocks [A-B] and [A-C], and represented by the formula -[A-B]ₙ-[A-C]ₘ— (I), wherein A, B, C, n and m are as defined herein, a porous membrane comprising the same, a method of producing the hydrophilic polyimides and the porous membrane, a liquid phase separation system comprising the porous membrane, and a liquid phase separation method.

In the present document, the numbers between brackets ([ ]) refer to the List of References provided at the end of the document.

### BACKGROUND OF THE INVENTION

Synthetic membranes are generally used for a variety of applications including desalination, gas separation, bacterial and particle filtration, and dialysis. The properties of the membranes depend on their morphology, i.e., properties such as cross-sectional symmetry or asymmetry, pore sizes, pore shapes and the polymeric material from which the membrane is made. These membranes could be hydrophobic or hydrophilic according to reaction conditions, dope composition, their manufacturing methodologies including post treatment processes. Membranes can be divided into four types depending on their application: microfiltration, ultra-filtration, nano-filtration and osmosis.

Ultrafiltration membranes are extensively used for environmental food processing and biochemical applications because of their low energy consumption, compact design, and simplicity of operation and scalability. A desirable ultrafiltration membrane should have not only high separation performance but also good antifouling properties. Membrane fouling by natural organic matter (NOM) and protein lead to significant capital and operational costs in membrane applications.

Sulfone based polymers, with —SO₂ group in the backbone, such as polysulfone (PSF) and polyethersulfone (PES) are the most widely used polymers for the development of ultrafiltration membrane due to its excellent thermal and chemical stability, and mechanical strength. They are used in a wide variety range of applications, such as hemodialysis, water treatment, protein purification and fractionation. However, membrane fouling, which is caused by the inherently hydrophobic nature of these polymers, dramatically decreases the membrane performance and lifetime and is a major roadblock for membrane applications. Hydrophilic membranes are less prone to fouling when used in particulate or colloidal suspensions: membrane materials with higher hydrophilicity can strongly bond with the water layer on the surface, which effectively reduces the membrane-foulant hydrophobic interactions and consequently lessen the membrane fouling. Therefore, several techniques have been applied to improve the PSF based membranes hydrophilicity and its filtration properties such as thin-film coating, UV induced surface grafting, redox initiated grafting, oxygen plasma treatment and post functionalization by adding hydrophilic functional groups to the polymer chain via carboxylation and amination. However, the main disadvantages of these methods are the additional complicated steps as well as severe alteration of the surface pores structure of the membranes while the internal pores are barely modified. Another strategy to enhance the membrane hydrophilicity is through the incorporation of inorganic fillers, hydrophilic polymers, such as polyethylene glycol (PEG) and polyvinyl pyrrolidone (PVP), and amphiphilic copolymers. For example, polysulfone-block-polyethylene glycol copolymers were blended with PSF. The blend membranes usually exhibited higher hydrophilicity, and fouling resistance compares with the neat polymer. However, the blend membranes usually suffer from long-term stability and low mechanical properties. The major proportion of the hydrophilic additives or fillers my leach out during the membrane fabrication process, such as phase inversion, or may agglomerate during the operation process.

The foregoing shows that there is an unmet need for hydrophilic membranes with improved resistance to fouling, as well as good thermal and mechanical properties combined with high separation performance; and for a method of imparting hydrophilicity and improved fouling resistance to membranes.

### BRIEF SUMMARY OF THE INVENTION

Thus it is an object of the invention to provide a hydrophilic polyimide membrane with reduced fouling propensity, with high separation performance, while maintaining good thermal stability and mechanical properties.

Improving upon known ultra-filtration membranes it is proposed according to the invention a hydrophilic polyimide including at least one type of building blocks [A-B] and [A-C], and represented by the formula -[A-B]ₙ-[A-C]ₘ— (I), wherein:
the n-bracketed building blocks and the m-bracketed building blocks are randomly distributed over the polyimide chain;
repeat unit A results from a monomer comprising two carboxylic anhydride moieties,
repeat unit B is hydrophilic and results from a first hydrophilic monomer comprising two primary amine moieties and at least one further hydrophilic moiety different from the primary amines, and
repeat unit C is hydrophilic and results from a second hydrophilic monomer comprising two primary amine moieties and at least one further hydrophilic moiety different from the primary amines;
wherein:
n and m represent independently an integer from 0 to about 1000; wherein n+m is an integer from about 10 to about 1000.

The present invention also provides a method of preparing a hydrophilic polyimide according to the invention, comprising:
(i) providing:
   a monomer A comprising two carboxylic anhydride moieties;
   a first hydrophilic monomer B comprising two primary amine moieties and at least one further hydrophilic moiety different from the primary amines; and
   optionally a second hydrophilic monomer C comprising two primary amine moieties and at least one further hydrophilic moiety different from the primary amines; wherein the molar ratio A/(B+C) is about 1; and
(ii) carrying out cycloimidization polymerization of the first hydrophilic monomer, and optionally the second hydrophilic monomer, with the monomer comprising two carboxylic anhydride moieties.

In another aspect, the present invention provides a porous membrane comprising a hydrophilic polyimide according to the invention.

The present invention also provides a method of preparing a porous membrane comprising a hydrophilic polyimide according to the invention, said method comprising:
providing a polymer solution comprising a solvent and said hydrophilic polyimide;
(ii) casting the polymer solution as a thin film; and
(iii) subjecting the thin film to coagulation in deionized water.

The present invention also provides a liquid phase separation system comprising the porous membrane according to the invention.

The present invention also provides a liquid phase separation method comprising a step of selectively permeating proteins from an aqueous phase containing proteins, using the liquid phase separation system according to the invention.

### BRIEF DESCRIPTION OF THE DRAWINGS

FIG. 1 depicts FTIR Spectra of hydrophilic polyimides according to the invention detailed in the Examples.

FIG. 2 depicts TGA profiles of hydrophilic polyimides according to the invention detailed in the Examples.

FIG. 3 depicts X-ray diffraction patterns of hydrophilic polyimides according to the invention detailed in the Examples.

FIG. 4 depicts cross section SEM morphology of porous membrane prepared from the hydrophilic polyimides according to the invention, detailed in the Examples. (a) S-PI-1, (b) S-PI-2, (c) S-PI-3, (d) S-PI-4, (e) S-PI-5, (f) S-PI-7, (g) S-PI-8, (h) S-PI-9 and (i) S-PI-10. Scalebars are 2 μm.

FIG. 5 depicts the static water contact angle measurement of porous membrane prepared from the hydrophilic polyimides according to the invention, detailed in the Examples.

FIG. 6 depicts the relative water flux reduction of hydrophilic polyimides according to the invention detailed in the Examples.

FIG. 7 depicts the filtration/separation performance of porous ultra-filtration membranes prepared from the hydrophilic polyimides according to the invention, detailed in the Examples.

### DEFINITIONS

To facilitate an understanding of the present invention, a number of terms and phrases are defined below:

As used herein other than the claims, the terms “a,” “an,” “the,” and/or “said” means one or more. As used herein in the claims, when used in conjunction with the words “comprise,” “comprises” and/or “comprising,” the words “a,” “an,” “the,” and/or “said” may mean one or more than one. As used herein and in the claims, the terms “having,” “has,” “is,” “have,” “including,” “includes,” and/or “include” has the same meaning as “comprising,” “comprises,” and “comprise.” As used herein and in the claims “another” may mean at least a second or more.

The phrase “a mixture thereof” and such like following a listing, the use of “and/or” as part of a listing, a listing in a table, the use of “etc.” as part of a listing, the phrase “such as,” and/or a listing within brackets with “e.g.,” or i.e., refers to any combination (e.g., any sub-set) of a set of listed components, and combinations and/or mixtures of related species and/or embodiments described herein though not directly placed in such a listing are also contemplated. Such related and/or like genera(s), sub-genera(s), specie(s), and/or embodiment(s) described herein are contemplated both in the form of an individual component that may be claimed, as well as a mixture and/or a combination that may be described in the claims as “at least one selected from,” “a mixture thereof” and/or “a combination thereof.”

In general, the term “substituted” whether preceded by the term “optionally” or not, means that one or more hydrogens of the designated moiety are replaced with a suitable substituent. Unless otherwise indicated, an “optionally substituted” group may have a suitable substituent at each substitutable position of the group, and when more than one position in any given structure may be substituted with more than one substituent selected from a specified group, the substituent may be either the same or different at every position. As used herein, the term “substituted” is contemplated to include all permissible substituents of organic compounds.

Suitable monovalent substituents on a substitutable carbon atom of an “optionally substituted” group include independently halogen; C1-6alkyl, C2-6alkenyl, C2-6alkynyl, —O—C1-6alkyl, —O—C2-6alkenyl, —O—C2-6alkynyl, C6-10aryl, -0-C6-10aryl, heteroaryl or —O-heteroaryl having 1-4 heteroatoms independently selected from nitrogen, oxygen, or sulfur, heterocyclyl, alicyclyl, —NO₂; —CN for example, wherein each of the foregoing alkyl, alkenyl and alkynyl groups may be independently interrupted by one or more oxygen atoms.

Suitable divalent substituents on a saturated carbon atom of an “optionally substituted” group include ═O, ═S, for example.

Suitable substituents on a substitutable nitrogen of an “optionally substituted” group include C1-6alkyl, C2-6alkenyl, C2-6alkynyl, C6-10aryl, aryl ring having 0-4 heteroatoms independently selected from nitrogen, oxygen, or sulfur, heterocyclyl, alicyclyl, for example.

The term “aliphatic”, as used herein, includes both saturated and unsaturated, straight chain (i.e., unbranched) or branched aliphatic hydrocarbons, which are optionally substituted with one or more functional groups. As will be appreciated by one of ordinary skill in the art, “aliphatic” is intended herein to include, but is not limited to, alkyl, alkenyl, alkynyl moieties, as defined below.

As used herein, the term “alkyl”, refers to straight and branched C1-C10alkyl groups. An analogous convention applies to other generic terms such as “alkenyl”, “alkynyl” and the like. As used herein, “lower alkyl” is used to indicate those alkyl groups (substituted, unsubstituted, branched or unbranched) having about 1-6 carbon atoms. Illustrative alkyl groups include, but are not limited to, for example, methyl, ethyl, n-propyl, isopropyl, allyl, n-butyl, sec-butyl, isobutyl, tert-butyl, n-pentyl, sec-pentyl, isopentyl, tert-pentyl, n-hexyl, sec-hexyl, moieties and the like, which again, may bear one or more substituents. Alkenyl groups include, but are not limited to, for example, ethenyl, propenyl, butenyl, 1-methyl-2-buten-1-yl, and the like. Representative alkynyl groups include, but are not limited to, ethynyl, 2-propynyl (propargyl), 1-propynyl and the like.

The term “alicyclic” or “cycloaliphatic”, as used herein, refers to compounds which combine the properties of aliphatic and cyclic compounds and include but are not limited to cyclic, or polycyclic aliphatic hydrocarbons and bridged cycloalkyl compounds, which are optionally substituted with one or more functional groups. As will be appreciated by one of ordinary skill in the art, “alicyclic” is intended herein to include, but is not limited to, cycloalkyl, cycloalkenyl, and cycloalkynyl moieties, which are optionally substituted with one or more functional groups. Illustrative alicyclic groups thus include, but are not limited to, for example, cyclopropyl, —CH₂-cyclopropyl, cyclobutyl, —CH₂-cyclobutyl, cyclopentyl, —CH₂-cyclopentyl-n, cyclohexyl, —CH₂-cyclohexyl, cyclohexenylethyl, cyclohexanylethyl, norborbyl moieties and the like, which again, may bear one or more substituents.

The term “heteroaliphatic”, as used herein, refers to aliphatic moieties in which one or more carbon atoms in the main chain have been substituted with a heteroatom. Thus, a heteroaliphatic group refers to an aliphatic chain which contains one or more oxygen, sulfur, nitrogen, phosphorus or silicon atoms, i.e., in place of carbon atoms. Heteroaliphatic moieties may be branched or linear unbranched. An analogous convention applies to other generic terms such as “heteroalkyl”, “heteroalkenyl”, “heteroalkynyl” and the like.

The term “heterocyclic” or “heterocycle”, as used herein, refers to compounds which combine the properties of heteroaliphatic and cyclic compounds and include but are not limited to saturated and unsaturated mono- or polycyclic heterocycles such as morpholino, pyrrolidinyl, furanyl, thiofuranyl, pyrrolyl etc., which are optionally substituted with one or more functional groups, as defined herein. In certain embodiments, the term “heterocyclic” refers to a non-aromatic 5-, 6- or 7-membered ring or a polycyclic group, including, but not limited to a bi- or tri-cyclic group comprising fused six-membered rings having between one and three heteroatoms independently selected from oxygen, sulfur and nitrogen, wherein (i) each 5-membered ring has 0 to 2 double bonds and each 6-membered ring has 0 to 2 double bonds, (ii) the nitrogen and sulfur heteroatoms may optionally be oxidized, (iii) the nitrogen heteroatom may optionally be quaternized, and (iv) any of the above heterocyclic rings may be fused to an aryl or heteroaryl ring. Representative heterocycles include, but are not limited to, pyrrolidinyl, pyrazolinyl, pyrazolidinyl, imidazolinyl, imidazolidinyl, piperidinyl, piperazinyl, oxazolidinyl, isoxazolidinyl, morpholinyl, thiazolidinyl, isothiazolidinyl, and tetrahydrofuryl.

In general, the term “aromatic” or “aryl”, as used herein, refers to stable substituted or unsubstituted unsaturated mono- or polycyclic hydrocarbon moieties having preferably 3-14 carbon atoms, comprising at least one ring satisfying Hackle's rule for aromaticity. Examples of aromatic moieties include, but are not limited to, phenyl, indanyl, indenyl, naphthyl, phenanthryl and anthracyl.

As used herein, the term “heteroaromatic” or “heteroaryl” refers to unsaturated mono-heterocyclic or polyheterocyclic moieties having preferably 3-14 carbon atoms and at least one ring atom selected from S, O and N, comprising at least one ring satisfying the Hückel rule for aromaticity. Preferably, the heteroaromatic compound or heteroaryl may be a cyclic unsaturated radical having from about five to about ten ring atoms of which one ring atom is selected from S, O and N; zero, one or two ring atoms are additional heteroatoms independently selected from S, O and N; and the remaining ring atoms are carbon, the radical being joined to the rest of the molecule via any of the ring atoms, such as, for example, pyridyl, pyrazinyl, pyrimidinyl, pyrrolyl, pyrazolyl, imidazolyl, thiazolyl, oxazolyl, isooxazolyl, thiadiazolyl, oxadiazolyl, thiophenyl, furanyl, quinolinyl, isoquinolinyl, carbazolyl, dibenzo[b,d]thiophenyl, dibenzo[b,d]thiophene-5,5-dioxide, and the like. Examples of heteroaryl moieties include, but are not limited to, pyridyl, quinolinyl, dihydroquinolinyl, isoquinolinyl, quinazolinyl, dihydroquinazolyl, and tetrahydroquinazolyl.

As used herein, the term “heteroatom linker” refers to a divalent one to two-atom long linker comprising heteroatoms, such as O, S, N. Examples of such heteroatom linkers include SO₂, —O—, —S—, —S—S—, —N═N—, and the like.

As used herein, the term “one-atom long linker” refers to a linker separating two chemical subunits/moieties by exactly one atom, which may optionally bear other substituents than the chemical subunits. Examples of such one-atom long linkers include SO₂, —O—, —S—, C═O, C═S, C(CH₃)₂, C(CF₃)₂, and the like.

As used herein, the term “independently” refers to the fact that the substituents, atoms or moieties to which these terms refer, are selected from the list of variables independently from each other (i.e., they may be identical or the same). For example, in the structure “—NR—CX—NR—”, “each occurrence of R independently represents H or C1-6alkyl” means that the two R groups on the structure may be the same or different, and are each selected from H or C1-6alkyl, independently of one another.

As used herein, “about” refers to any inherent measurement error or a rounding of digits for a value (e.g., a measured value, calculated value such as a ratio), and thus the term “about” may be used with any value and/or range. As used herein, the term “about” can refer to a variation of ±5% of the value specified. For example, “about 50” percent can in some embodiments carry a variation from 45 to 55 percent. For integer ranges, the term “about” can include one or two integers greater than and/or less than a recited integer. Unless indicated otherwise herein, the term “about” is intended to include values, e.g., weight %, temperatures, proximate to the recited range that are equivalent in terms of the functionality of the relevant individual ingredient, the composition, or the embodiment.

As used herein, the term “and/or” means any one of the items, any combination of the items, or all of the items with which this term is associated.

As will be understood by the skilled artisan, all numbers, including those expressing quantities of ingredients, properties such as molecular weight, reaction conditions, and so forth, are approximations and are understood as being optionally modified in all instances by the term “about.” These values can vary depending upon the desired properties sought to be obtained by those skilled in the art utilizing the teachings of the descriptions herein. It is also understood that such values inherently contain variability necessarily resulting from the standard deviations found in their respective testing measurements.

As will be understood by one skilled in the art, for any and all purposes, particularly in terms of providing a written description, all ranges recited herein also encompass any and all possible subranges and combinations of subranges thereof, as well as the individual values making up the range, particularly integer values. A recited range (e.g., weight percents or carbon groups) includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc.

As will also be understood by one skilled in the art, all language such as “up to,” “at least,” “greater than,” “less than,” “more than,” “or more,” and the like, include the number recited and such terms refer to ranges that can be subsequently broken down into subranges as discussed above. In the same manner, all ratios recited herein also include all subratios falling within the broader ratio. Accordingly, specific values recited for radicals, substituents, and ranges, are for illustration only; they do not exclude other defined values or other values within defined ranges for radicals and substituents.

One skilled in the art will also readily recognize that where members are grouped together in a common manner, such as in a Markush group, the invention encompasses not only the entire group listed as a whole, but each member of the group individually and all possible subgroups of the main group. Additionally, for all purposes, the invention encompasses not only the main group, but also the main group absent one or more of the group members. The invention therefore envisages the explicit exclusion of any one or more of members of a recited group. Accordingly, provisos may apply to any of the disclosed categories or embodiments whereby any one or more of the recited elements, species, or embodiments, may be excluded from such categories or embodiments, for example, as used in an explicit negative limitation.

### DETAILED DESCRIPTION OF CERTAIN PREFERRED EMBODIMENTS OF THE INVENTION

As noted above, there is an unmet need for hydrophilic membranes with improved resistance to fouling, good thermal and mechanical properties, and high separation performance.

The present invention meets this need by providing a hydrophilic polyimide including at least one type of building blocks [A-B] and [A-C], and represented by the formula -[A-B]ₙ-[A-C]ₘ— (I), wherein:
the n-bracketed building blocks and the m-bracketed building blocks are randomly distributed over the polyimide chain;
repeat unit A results from a monomer comprising two carboxylic anhydride moieties,
repeat unit B is hydrophilic and results from a first hydrophilic monomer comprising two primary amine moieties and at least one further hydrophilic moiety different from the primary amines, and
repeat unit C is hydrophilic and results from a second hydrophilic monomer comprising two primary amine moieties and at least one further hydrophilic moiety different from the primary amines;
wherein:
n and m represent independently an integer from 0 to about 1000; wherein n+m is an integer from about 10 to about 1000.

The number of repeat units, n+m, within the hydrophilic polyimide copolymer can be from about 10 to about 1000, preferably from about 30 to about 300, and more preferably from about 50 to about 250.

The hydrophilic polyimide copolymer according to the present invention may have a molecular weight ranging from about 10,000 to about 1,000,000 g/mol, preferably from about 30,000 to about 500,000 g/mol, more preferably from about 40,000 to about 300,000 g/mol, most preferably from about 50,000 to about 100,000 g/mol.

The hydrophilic polyimide copolymer according to the present invention may have a polydispersity index (PDI) ranging from about 0.7 to about 5.0, preferably from about 0.9 to about 4.0, more preferably from about 1.0 to about 3.0, most preferably from about 1.2 to about 2.8. In the context of the present invention, the hydrophilic polyimide copolymer PDI may be measured by gel permeation chromatography according to standard methods ASTM D5296 and ISO 13885-1.

In the case of a tri-block polyimide, building block [A-B] may be present in the hydrophilic polyimide in an amount of about 10% to about 90 mol % and building block [A-C] may be present in an amount of about 90% to about 10 mol % (the sum [A-B] building blocks+[A-C] building blocks being 100%). For example, the following molar % may be used:

TABLE 1

| Building block [A-B] | Building block [A-C] |
|---|---|
| 100 | 0 |
| 90 | 10 |
| 80 | 20 |
| 75 | 25 |
| 70 | 30 |
| 60 | 40 |
| 50 | 50 |
| 40 | 60 |
| 30 | 70 |
| 25 | 75 |
| 20 | 80 |
| 10 | 90 |
| 0 | 100 |

As such, in hydrophilic polyimides according to the invention having formula -[A-B]ₘ-[A-C]ₘ— (I), the molar ratio of repeat units B and C may each independently range from 10-90% (the sum B+C being 100%), and the molar ratio of repeat units A equals the sum of the molar ratio B+C.

The hydrophilic polyimide of formula -[A-B]ₙ-[A-C]ₘ— (I), may comprise one or more, preferably one or two, terminal functional groups selected from amino or carboxyl groups, preferably primary amino groups or carboxyl groups.

Monomer A Comprising Two Carboxylic Anhydride Moieties

Advantageously, the monomer comprising two carboxylic anhydride moieties may have the structure (III):

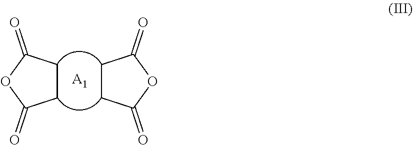

wherein A₁ represents a cyclic or acyclic moiety linking both carboxylic anhydride groups.

As such, the hydrophilic polyimide according to the invention, including at least one type of building blocks [A-B] and [A-C], and represented by the formula -[A-B]ₙ-[A-C]ₘ— (I), may be represented as follows:

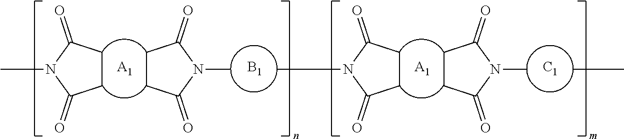

wherein the n-bracketed building blocks and the m-bracketed building blocks are randomly distributed over the polyimide chain; n and m represent independently an integer from 0 to about 1000; wherein n+m is an integer from about 10 to about 1000; and A₁, B₁ and C₁ may be as defined in any variant herein. Preferably, in the hydrophilic polyimide according to the invention, of formula -[A-B]ₙ-[A-C]ₘ— (I), the molar ratio of repeat units B and C may each be independently from 10-90%, and the molar ratio of repeat units A may equal the sum of the molar ratio B+C.

A₁ may be an aliphatic, heteroaliphatic, aromatic or heteroaromatic moiety. Preferably, A₁ may be a cyclic moiety forming a fused polycyclic ensemble together with the two anhydride moieties. Preferably, A₁ may comprise at least one aromatic or heteroaromatic, preferably aromatic, ring, which may be optionally substituted.

Advantageously, the monomer comprising two carboxylic anhydride moieties may have the structure (VI):

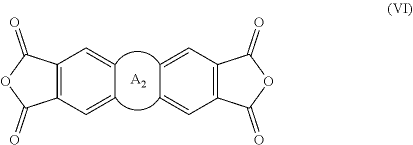

wherein A₂ represents a cyclic or acyclic moiety linking both benzene carboxylic anhydride groups;

As such, the hydrophilic polyimide according to the invention, including at least one type of building blocks [A-B] and [A-C], and represented by the formula -[A-B]ₙ-[A-C]ₘ— (I), may be represented as follows:

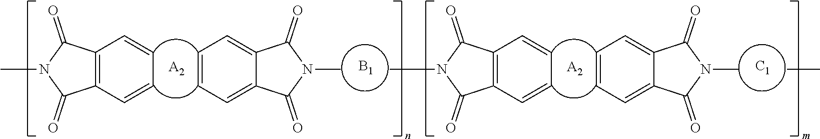

wherein the n-bracketed building blocks and the m-bracketed building blocks are randomly distributed over the polyimide chain; n and m represent independently an integer from 0 to about 1000; wherein n+m is an integer from about 10 to about 1000; and A₂, B₁ and C₁ may be as defined in any variant herein.

A₂ may be an aliphatic, heteroaliphatic, aromatic or heteroaromatic moiety, or a heteroatom linker. Preferably, A₂ may be an acyclic moiety, preferably hydrophilic, bridging the two benzene carboxylic anhydride groups. Preferably, A₂ may be a one-atom long linker X₁, preferably hydrophilic, bridging the two benzene carboxylic anhydride groups.

Preferably, A₂ may be a hydrophilic linker X₁, and the monomer A may have the structure (VII):

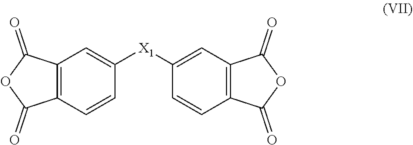

wherein X₁ represents C═O, SO₂, —O— or C(CF₃)₂. In exemplary embodiments, X1 may represent C═O, SO₂, or C(CF₃)₂.

As such, the hydrophilic polyimide according to the invention, including at least one type of building blocks [A-B] and [A-C], and represented by the formula -[A-B]ₙ-[A-C]ₘ— (I), may be represented as follows:

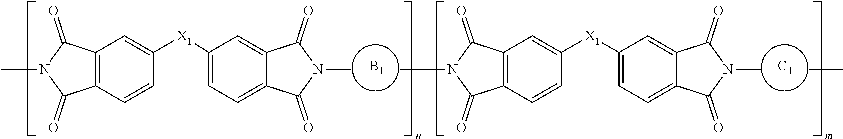

wherein the n-bracketed building blocks and the m-bracketed building blocks are randomly distributed over the polyimide chain; n and m represent independently an integer from 0 to about 1000; wherein n+m is an integer from about 10 to about 1000; X₁ represents a hydrophilic one-atom long linker, such as C═O, SO₂, —O— or C(CF₃)₂; preferably C═O, SO₂, or C(CF₃)₂; and B₁ and C₁ may be as defined in any variant herein.

First Hydrophilic Monomer B

Advantageously, the first hydrophilic monomer may have the structure (IV):

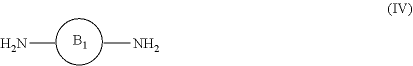

wherein B1 represents an aliphatic, alicyclic, heteroaliphatic, heterocyclic, aromatic or heteroaromatic moiety, further bearing at least one hydrophilic monovalent or divalent group selected from —C(═O)OH, —OH, —OR, —NO₂, —SH, —SO₂H, —SO₂R, —SO₂—, or an ether moiety —CX—O—R, wherein X represents a monovalent substituent, and each occurrence of R independently represents C1-6alkyl or C6-10aryl.

Advantageously, B₁ may be a heterocyclic, aromatic or heteroaromatic moiety, preferably an aromatic moiety, further bearing at least one hydrophilic group as described immediately above.

Advantageously, B₁ may be a phenyl moiety and the first hydrophilic monomer comprising two primary amine moieties may have the structure (VIII):

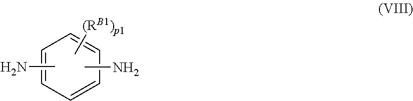

wherein
p1 represents 1 or 2; preferably 1;
each occurrence of R^{B1} independently comprises or represents a hydrophilic monovalent or divalent group selected from —C(═O)OH, —OH, —OR, —NO₂, —SH, —SO₂H, —SO₂R, —SO₂—, or an ether moiety —CX—O—R, wherein X represents a monovalent substituent, and each occurrence of R independently represents C1-6allyl or C6-10aryl.

Preferably, in the structure VIII, each occurrence of R^{B1} may be independently —C(═O)OH, and p1 represents 1 or 2; preferably 1.

The monovalent substituent X may be for example, H, C1-6alkyl or C1-6heteroalkyl.

Preferably, the first hydrophilic monomer comprising two primary amine moieties may have the structure (IX):

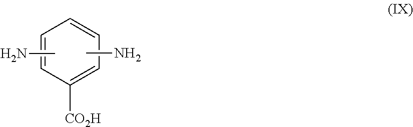

more preferably

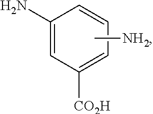

most preferably

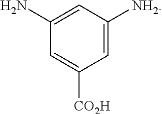 [SMILES: Nc1cc(N)cc(C(=O)O)c1]

As such, the hydrophilic polyimide according to the invention, including at least one type of building blocks [A-B] and [A-C], and represented by the formula -[A-B]ₙ-[A-C]ₘ— (I), may be represented as follows:

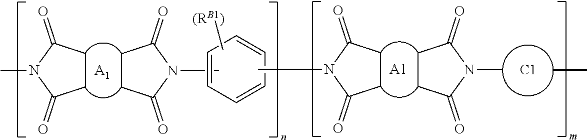

for example:

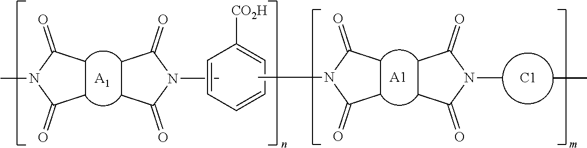

wherein the n-bracketed building blocks and the m-bracketed building blocks are randomly distributed over the polyimide chain; n and m represent independently an integer from 0 to about 1000; wherein n+m is an integer from about 10 to about 1000; and A₁, p₁, R^{B1} and C₁ may be as defined in any variant herein.

For example, the hydrophilic polyimide according to the invention may be represented as follows:

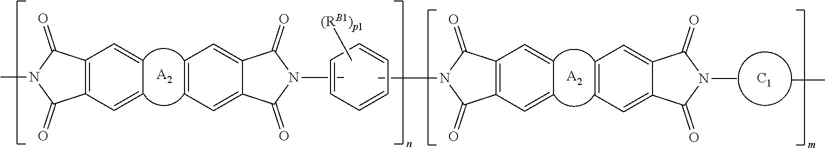

for example:

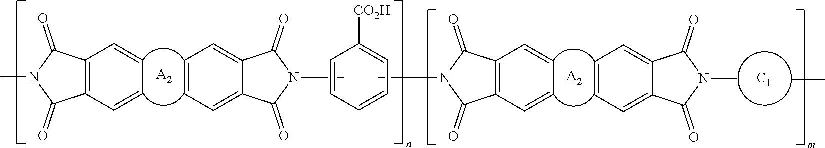

wherein the n-bracketed building blocks and the m-bracketed building blocks are randomly distributed over the polyimide chain; n and m represent independently an integer from 0 to about 1000; wherein n+m is an integer from about 10 to about 1000; and A₂, p₁, R^{B1} and C₁ may be as defined in any variant herein.

In exemplary embodiments, the hydrophilic polyimide according to the invention may be represented as follows:

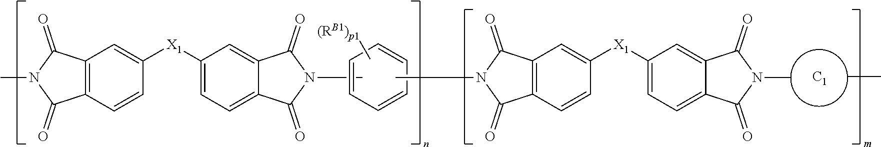

for example:

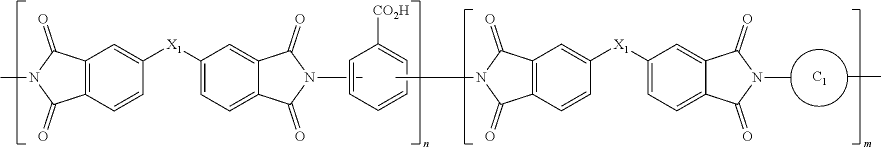

wherein the n-bracketed building blocks and the m-bracketed building blocks are randomly distributed over the polyimide chain; n and m are as defined above; X₁ represents a hydrophilic one-atom long linker, such as C═O, SO₂, —O— or C(CF₃)₂; preferably X1 represents C═O, SO₂, or C(CF₃)₂; and C₁ may be as defined in any variant herein.

Second Hydrophilic Monomer C

Advantageously, the second hydrophilic monomer comprising two primary amine moieties may have the structure (V)

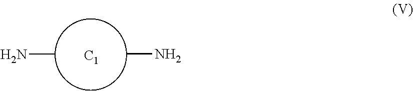

wherein C₁ represents an aliphatic, alicyclic, heteroaliphatic, heterocyclic, aromatic, heteroaromatic moiety; bearing at least one hydrophilic di-valent group selected from —SO₂—, —NR^{C1}—, —NR^{C1}—CW—NR^{C1}—, —S—, or —S—S—; or else C₁ represents a polyethylene oxide moiety;
wherein W represents a monovalent substituent, and each occurrence of R^{C1} independently represents H or C1-6alkyl.

Advantageously, C₁ may be a heterocyclic, aromatic or heteroaromatic moiety, preferably an aromatic moiety, further bearing at least one hydrophilic group as described immediately above. In a preferred embodiment, the at least one hydrophilic group may be —SO₂—.

Advantageously, C₁ may be a fused polycyclic moiety comprising at least one aromatic group. For example, the second hydrophilic monomer comprising two primary amine moieties may have the structure (X):

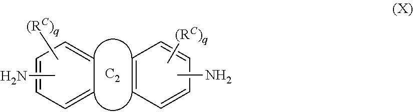

wherein
C₂ represents a cyclic or acyclic moiety linking the two phenyl groups, bearing at least one hydrophilic di-valent group selected from —SO₂—, —NR^{C1}—, —NR^{C1}—CW—NR^{C1}—, —S—, or —S—S—; preferably —SO₂—; wherein each occurrence of R^{C1} independently represents H or C1-6alkyl; and W represents a monovalent substituent;
each occurrence of R^{C} independently represents H or C1-6alkyl; and each occurrence of q independently represents 0, 1 or 2. For example, each occurrence of R^{C} may independently represent H, methyl or ethyl, preferably H or methyl.

The monovalent substituent W may be for example H, C1-6alkyl or C1-6heteroalkyl.

For example, the second hydrophilic monomer comprising two primary amine moieties may have the structure (XA):

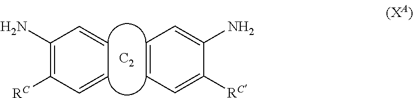

wherein C₂ is as defined above, and R^{C} and R^{C}′ independently represent H, methyl or ethyl, preferably H or methyl. Preferably, R^{C} and R^{C}′ both represent methyl.

Preferably, the second hydrophilic monomer comprising two primary amine moieties may have the structure (XI):

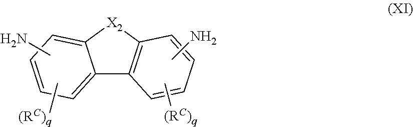

wherein
X₂ represents a hydrophilic di-valent group selected from —SO₂—, —NR^{C1}—, —NR^{C1}—CW—NR^{C1}—, —S—, or —S—S— where R^{C}′ and W are as defined above; preferably X₂ represents —SO₂—;
each occurrence of R^{C} independently represents H or C₁-6alkyl; and
each occurrence of q independently represents 0, 1 or 2. For example, each occurrence of R^{C} may independently represent H, methyl or ethyl, preferably H or methyl.

For example, the second hydrophilic monomer comprising two primary amine moieties may have the structure (XI^{A}):

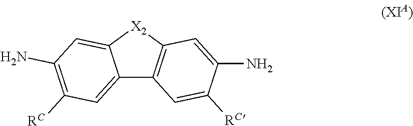

wherein
X₂ represents a hydrophilic di-valent group selected from —SO₂—, —NR^{C1}—, —NR^{C1}—CW—NR^{C1}, —S—, or —S—S— where R^{C1} and W are as defined above; preferably X₂ represents —SO₂—; and
R^{C} and R^{C}′ independently represent H, methyl or ethyl, preferably H or methyl. Preferably, R^{C} and R^{C}′ represent methyl.

As such, the hydrophilic polyimide according to the invention, including at least one type of building blocks [A-B] and [A-C], and represented by the formula -[A-B]ₙ-[A-C]ₘ— (I), may be represented as follows:

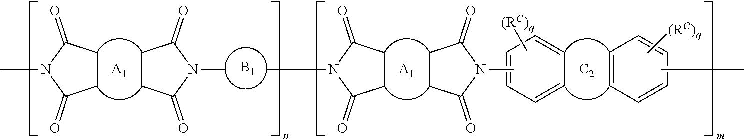

for example:

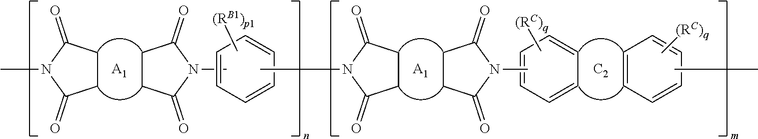

in particular:

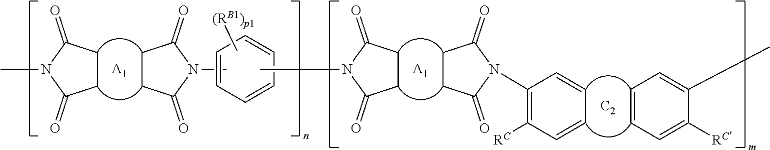

more particularly

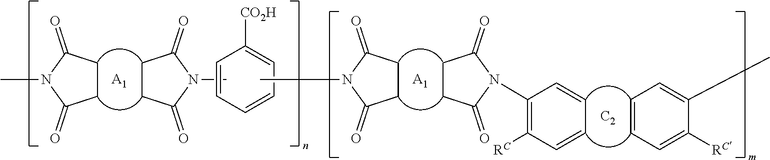

wherein the n-bracketed building blocks and the m-bracketed building blocks are randomly distributed over the polyimide chain; n and m represent independently an integer from 0 to about 1000; wherein n+m is an integer from about 10 to about 1000; and A₁, B₁, p₁, R^{B1}, q, R^{C}, R^{C′} and C₂ may be as defined in any variant herein.

For example, the hydrophilic polyimide according to the invention may be represented as follows:

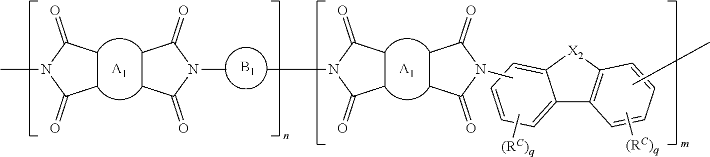

for example:

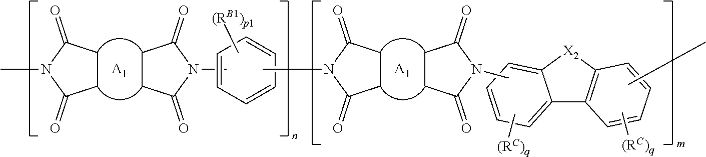

in particular:

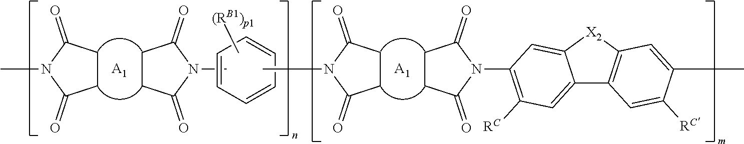

more particularly:

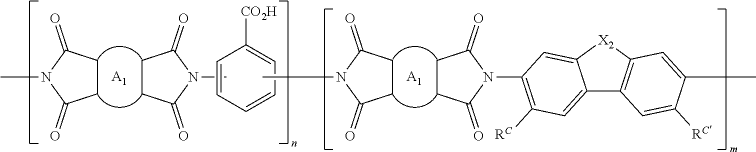

wherein:
the n-bracketed building blocks and the m-bracketed building blocks are randomly distributed over the polyimide chain; n and m represent independently an integer from 0 to about 1000; wherein n+m is an integer from about 10 to about 1000;
X₂ represents a hydrophilic di-valent group selected from —SO₂—, —NR^{C1}—, —NR^{C1}—CW—NR^{C1}—, —S—, or —S—S— where each occurrence of R^{C1} independently represents H or C1-6alkyl; and W represents a monovalent substituent; preferably X₂ represents —SO₂—; and
A₁, B₁, p₁, R^{B1}, q, R^{C}, and R^{C′} may be as defined in any variant herein.

In a variant, the second hydrophilic monomer comprising two primary amine moieties may be a diamino-functionalized polyether of the structure (XII):

H₂N—PEO—NH₂ (XII)
wherein PEO represents a polyether chain, preferably a polyalkylether chain, such as polyethylene oxyde or polyethylene glycol, of molecular weight from 200 to 10,000 g/mol.

Diamino polyethers may be obtained for example from chemical suppliers such as Sigma-Aldrich, or Huntsman Co. (e.g., Jeffamine® series).

A wide variety of diamino polyethers (or polyetheramines) may be used. For example, the following may be mentioned:

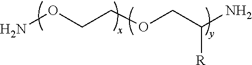

R = H for (EO), or CH₃ for (PO)

| JEFFAMINE ® | PO/EO mol ratio | MW* |
|---|---|---|
| M-600 (XTJ-505) | 9/1 | 600 |
| M-1000 (XTJ-506) | 3/19 | 1,000 |
| M-2005 | 29/6 | 2,000 |
| M-2070 | 10/31 | 2,000 |

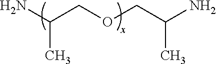

| JEFFAMINE ® | x | MW* |
|---|---|---|
| D-230 | ~2.5 | 230 |
| D-400 | ~6.1 | 430 |
| D-2000 | ~33 | 2,000 |
| D-4000 (XTJ-510) | ~68 | 4,000 |

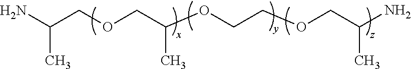

| JEFFAMINE ® | y | x + z | MW* |
|---|---|---|---|
| HK-511 | 2.0 | ~1.2 | 220 |
| ED-600 (XTJ-500) | ~9.0 | ~3.6 | 600 |
| ED-900 (XTJ-501) | ~12.5 | ~6.0 | 900 |
| ED-2003 (XTJ-502) | ~39 | ~6.0 | 2,000 |

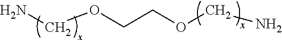

| JEFFAMINE ® | x | MW |
|---|---|---|
| EDR-148 (XTJ-504) | 2.0 | 148 |
| EDR-176 (XTJ-590) | 3.0 | 176 |

*MW = approximate molecular weight

As such, in another exemplary variant, the hydrophilic polyimide according to the invention, including at least one type of building blocks [A-B] and [A-C], and represented by the formula -[A-B]ₙ-[A-C]ₘ— (I), may be represented as follows:

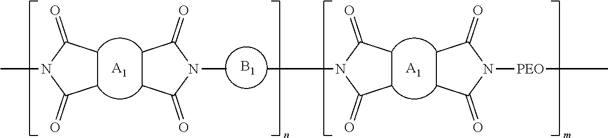

for example:

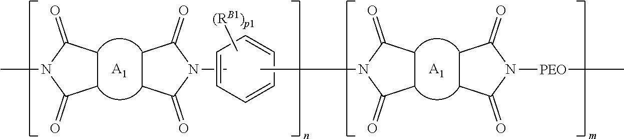

in particular:

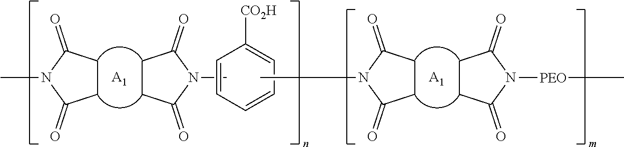

wherein the n-bracketed building blocks and the m-bracketed building blocks are randomly distributed over the polyimide chain; n and m represent independently an integer from 0 to about 1000; wherein n+m is an integer from about 10 to about 1000;
PEO represents a polyether chain, preferably a polyalkylether chain, of molecular weight from 200 to 10,000 g/mol, such as polyethylene oxyde, polyethylene glycol or a Jeffamine polyether chain as described above; and
A₁, B₁, p₁, and R^{B1} may be as defined in any variant herein.

The polyimides according to the invention are hydrophilic, and present advantageous properties notably in terms of thermal stability, mechanical strength and separation performance.

Hydrophilic polyimides according to the invention typically exhibit a sessile water drop contact angle <90°, as measured with 1-10 μL (e.g., 4 μL) deionized water drops at ambient air conditions. Preferably, hydrophilic polyimides according to the invention exhibit a sessile water drop contact angle 80° at ambient air conditions, as measured with 4 μL deionized water drops at ambient air conditions, preferably ≤70°, more preferably ≤60°, yet more preferably ≤50°, even as low as 45°. With “ambient air” conditions it is understood a relative humidity in the range of 20-60% RH, at a temperature in the range of 20-25° C., and atmospheric pressure.

Polyimide Synthesis

In another aspect, the present invention provides a method of preparing a hydrophilic polyimide according to the invention, comprising:
(i) providing:
   a monomer A comprising two carboxylic anhydride moieties;
   a first hydrophilic monomer B comprising two primary amine moieties and at least one further hydrophilic moiety different from the primary amines; and
   optionally a second hydrophilic monomer C comprising two primary amine moieties and at least one further hydrophilic moiety different from the primary amines; wherein the molar ratio A/(B+C) is about 1; and
(ii) carrying out cycloimidization polymerization of the first hydrophilic monomer, and optionally the second hydrophilic monomer, with the monomer comprising two carboxylic anhydride moieties.

In the above method:
(a) the monomer A comprising two carboxylic anhydride moieties,
(b) the first hydrophilic monomer B, and
(c) the optional second hydrophilic monomer C, may be as defined generally and in any variant herein.

Specifically:
(a) the monomer A comprising two carboxylic anhydride moieties may have structure (III), (VI), or (VII) as described herein;
(b) the first hydrophilic monomer B may have structure (IV), (VIII), or (IX) as described herein; and
(c) the optional second hydrophilic monomer C may have structure (V), (X), (XI) or (XII) as described herein.

Each of monomer B and C may be used in 10 to 90 molar %. For example, the molar % ratio B/C may as detailed in Table 1 above. The molar ratio between monomers B/C may be about 1.

Advantageously, the cycloimidization polymerization may be carried out in a suitable solvent system, particularly a polar solvent system. Examples of suitable solvents that may be used include N,N-dimethylacetamide, N,N-dimethylformamide, dimethyl sulfoxide, and N-methylpyrrolidone, and mixtures of two or more thereof.

Advantageously, the cycloimidization polymerization is conducted such that the ratio of the monomer A to the sum of monomers B+C in the reaction mixture is preferably about 1:1.

The cycloimidization polymerization may be distinguished into two phases:
a first phase comprising the condensation polymerization of the monomer A with the diamine monomers B and/or C.
a second phase comprising the cycloimidization of the condensation polymer, preferably with concomitant removal of water released with the cycloimidization reaction.

The cycloimidization phase may advantageously be carried out in the presence of a tertiary amine, as catalyst, such as quinoline.

The condensation phase may be conducted at a suitable temperature, for example, from 25° C. to about 120° C., preferably about 50° C. to about 110° C., and more preferably about 60° C. to 100° C. For example, it may be carried out in DMF at 65-75° C. The condensation phase can be carried out for any suitable length of time, for example, about 1 hr to about 72 hours or more, preferably about 2 hours to about 20 hours, more preferably about 3 hours to about 12 hours. The polymerization time can vary depending on, among others, the degree of polymerization desired and the temperature of the reaction mixture.

The cycloimidization phase may be conducted at a suitable temperature, for example, from 70° C. to about 250° C., preferably about 90° C. to about 250° C., and more preferably about 100° C. to 230° C. For example, it may be carried out using quinoline as catalyst, at about 220° C. The cycloimidization phase can be carried out for any suitable length of time, for example, about 1 hour to about 24 hours or more, preferably about 2 hours to about 15 hours, more preferably about 3 hours to about 10 hours, for example about 5 hours. The cycloimidization time and temperature can vary depending on, among others, the solvent/co-solvent used for azeotropic removal of water.

In exemplary embodiments, the overall reaction may be schematized as follows in Scheme 1 (for a cycloimidization process involving 3 different blocks: A₁, B₁ and C₁):

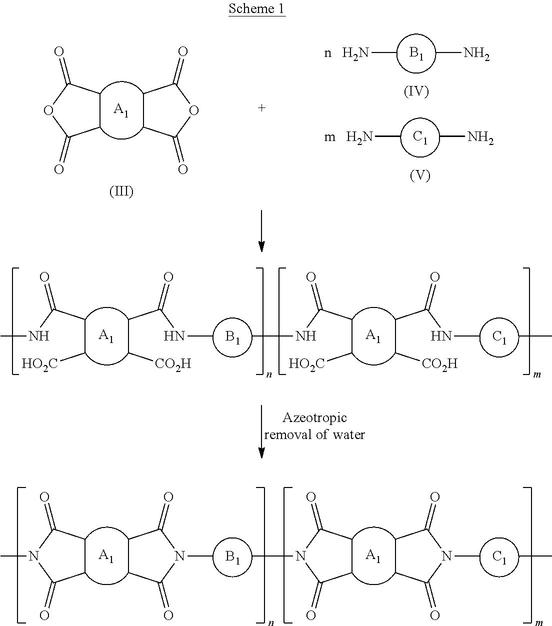

The result is a tri-block polyimide, where the n and m building blocks may be distributed randomly over the polyimide structure. Although there is no specific control on the order of the n- and m-bracketed building blocks, the molar ratio of the building blocks (n/m) may be adjusted by the initial molar ratio of the diamine monomers (IV) and (V).

Advantageously, removal of water generated by the reaction, for example azeotropic removal of water, may be carried out in a second stage, after the initial condensation polymerization reaction has been completed. This may be carried out using any solvent forming a binary azeotropic mixture with water, preferably one that is also a solvent for the polyimide and that would not interfere with the cycloimidization reaction. For example, suitable solvents that may be used for that purpose include:
alkyl halide solvents, such as ethylene chloride, propylene chloride, chloroform, carbon tetrachloride, or methylene chloride;
ester solvents such as ethyl acetate, methyl acetate, n-propyl acetate, or ethyl nitrate;
aromatic hydrocarbons such as benzene, toluene or m-xylene;
ether solvents such as diethyl ether or tetrahydrofuran;
other suitable solvents include 1,4-dioxane, acetone, methyl ethyl ketone, pyridine, or acetonitrile.

For example, toluene or 1,4-dioxane may be used for azeotropic removal of water. As such, the method of preparing a hydrophilic polyimide according to the invention may further comprise a step (iii) of adding to the reaction mixture, an organic solvent forming a binary azeotropic mixture with water, such as any one or more of the aforementioned solvents; and performing azeotropic removal of water. This may be accomplished by bringing the overall mixture to boiling point with concomitant distillation/removal of water from the azeotropic mixture. Alternatively, the water generated in situ by the condensation/cycloimidization reaction may be removed during the course of the reaction by distillation. For example, when a high boiling solvent such as NMP is used as organic solvent, the reaction mixture may be brought to 220° C., and distilled for 4-10 hours to remove the water and drive the cycloimidization to completion.

In other exemplary variants, the cycloimidization may be effected using dianhydride (III) and diamine (IV), as defined generally and in any variant herein. Alternatively, the cycloimidization may be effected using dianhydride (III) and diamine (V), as defined generally and in any variant herein. Both of these strategies would provide homo-polyimides.

The cycloimidization reaction using dianhydride (III) and diamine (IV) may be schematized as follows in Scheme 2 (for a cycloimidization process involving two different blocks: for example A₁ and B₁):

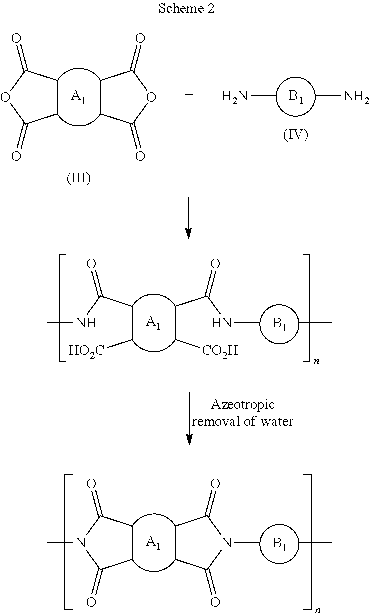

A similar Scheme would be obtained for a cycloimidization reaction using dianhydride (III) and diamine (V), leading to a homo-polyimide with building blocks A₁ and C₁.

Although cycloimidization reactions between a dianhydride and a diamine, to form a homo-polyimide of formula -[A-B]ₙ-(I^{A}), or -[A-C]ₘ— (I^{B}), wherein A, B, C, n and m are as defined generally and in any variant herein, cycloimidization reactions between three building blocks to form tri-block polyimide of formula -[A-B]ₙ-[A-C]ₘ— (I), wherein A, B, C, n and m are as defined generally and in any variant herein, and wherein n and m are each an integer >0. Specifically, the use of two different diamine building blocks (referred to herein as “first” and “second” hydrophilic monomers) allows to modulate the properties of the end-polyimide to reach an optimal combination of hydrophilicity and mechanical properties.

For example, the second hydrophilic monomer may be selected to impart good mechanical properties to the end-polyimide (in addition to some degree of hydrophilicity due to the hydrophilic nature of the monomer used), while the first hydrophilic monomer may be selected to confer principally a hydrophilic character to the end-polyimide. This would be the case, for example if the following hydrophilic monomers were used:

| | Second hydrophilic monomer C |
|---|---|
| | (imparting some rigidity |
| First hydrophilic monomer B | to the end-polyimide) |
| 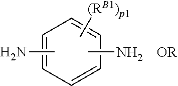 (VIII) | 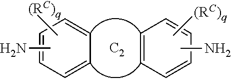 (X) Where C2 represents acyclic moiety minking the two phenyl groups OR |
| 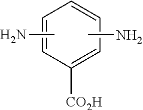 (IX) | 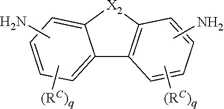 (XI) |

In another example, both first and second hydrophilic monomers may be selected to confer principally a hydrophilic character to the end-polyimide, with a lesser emphasis on rigidity. This would be the case, for example if the following hydrophilic monomers were used:

| First hydrophilic | Second hydrophilic |
|---|---|
| monomer B | monomer C |
| 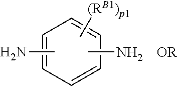 (VIII) | H₂N—PEO—NH₂ (XII) |
| 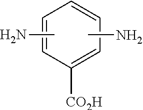 (IX) | |

As will be readily understood by the reader, depending on the choice of the starting dianhydride monomer and first and second hydrophilic monomers, a variety of hydrophilic polyimides may be achieved, within a broad range of mechanical properties.

The block copolyimide can be isolated from the reaction mixture by precipitation with a nonsolvent, e.g., water. The resulting copolyimide may be dried to remove any residual solvent or nonsolvent.

The block copolyimide can be characterized by any suitable analytical technique. For example, the structure of the copolyimide may be confirmed with FTIR, and the ratio between monomers A, B and may be determined/confirmed by proton NMR spectroscopy. The copolyimide thermal stability may be assessed using TGA, and its microstructure may be characterized using X-ray diffraction analysis.

Porous Membrane

In yet another aspect, the present invention provides a porous membrane comprising a hydrophilic polyimide according to the invention, as described generally and in any variant herein. Porous membranes comprising a copolyimide of the invention are hydrophilic. As such, they have a reduced fouling propensity, and are particularly useful in ultra-filtration applications.

The morphological parameters of the porous membranes according to the invention may be assessed using conventional techniques, including scanning electron microscopy (SEM), atomic force microscopy (AFM), confocal scanning laser microscopy (CSLM) and transmission electron microscopy (TEM). Alternatively, or additionally, X-ray computed microtomography (micro-CT), nuclear magnetic resonance (NMR), spin-echo small-angle neutron scattering (SESANS) and/or magnetic small-angle neutron scattering (MSANS) may be used (these techniques are generally faster and more complete techniques, as they can give a 3D (volume) analysis). With these techniques, morphological parameters of the porous membranes according to the invention may be assessed, such as pore size, pore size distribution, surface roughness, molecular weight cutoff and thickness.

Pore size represents the dimensions of the pores, which are channels of a variable cross-section. The distance between two opposite pore walls is used as the pore size for simple geometries (typically: diameter of cylindrical pores for pore size >2 nm, width of slit-shaped pores for pore size <2 nm). If the pores have irregular shapes, some averaging is made to report an average pore size. Methods for measuring pore size, average pore size, and pore size distribution of porous materials (cf. ISO 15901 norm), including some statistical analysis using a model such as nonlinear optimization and Monte Carlo integration for materials where the pores do not all have the same size and/or geometry.

Surface roughness is quantified by the deviations in the direction of the normal vector of an actual surface from its ideal geometric flat shape and dimensions.

The molecular weight cutoff (MWCO) refers to the lowest molecular weight solute (in Dalton) for which 90% of the solute is retained by the membrane, or the molecular weight of the molecule that is 90% retained by the membrane.

The thickness represents the distance between both surfaces (top and bottom or front and back) of a membrane.

Advantageously, porous membranes according to the invention exhibit an average pore size comprised between 1 nm and 50 nm.

As mentioned before, membranes can be divided into four types depending on their application: microfiltration, ultra-filtration, nano-filtration and osmosis. The classification corresponds to their average pore sizes which are in the range of 50-500 nm, ≤1-50 nm, nm and 0.3-0.6 nm, respectively. Accordingly, porous membranes according to the invention may be particularly useful in ultra-filtration applications.

Porous hydrophilic membranes according to the invention may be asymmetric. As used herein, “asymmetric” when referring to a membrane of the invention, means that the membrane pore size distribution is not uniform across the membrane thickness. Conversely, symmetrical membranes have uniform pore size distribution across the membrane thickness. Typically, for asymmetric membranes, a very thin dense surface layer is present acting as a functional layer on top of a porous sublayer with a specific pore diameter. An asymmetric membrane consists, for example, of a 0.1-1-μm-thick skin layer (the selective barrier) on a highly porous 100-200-μm-thick substructure. The pore size of the porous sublayer may be as low as nm and as high as 500 nm, the pore size range defining the type of application for which the asymmetric membrane may be used: microfiltration (50-500 nm), ultra-filtration (1-50 nm), nano-filtration nm) and osmosis (0.3-0.6 nm). The pore size and its distribution may be determined by numerical analysis of pore dimensions observed in electron micrographs of the membrane cross section. The aforementioned pore size numerical values represents the arithmetic mean of the distribution of pore sizes observed by scanning electron microscopy (SEM) over the membrane cross section.

Advantageously, the porous hydrophilic polyimide membranes according to the invention has a typical asymmetric structure which consists of a thin dense layer and a porous sub-layer. The thin dense layer may have a thickness of 0.1-1-μm, for example 50 nm to 1 μm, and the overall membrane thickness may range from 50 to 500 μm, for example 50-400 μm, for example 50-300 μm, for example 50-200 μm, for example about 100 μm.

Advantageously, the porous hydrophilic polyimide membrane according to the invention may have a pure water flux >60 L/h/m²/bar, preferably >100 L/h/m²/bar, most preferably >200 L/h/m²/bar, measured under 2 bar filtration pressure and 25° C.

Advantageously, the porous hydrophilic polyimide membrane according to the invention may exhibit a lysozyme rejection >80%, preferably >85%, more preferably >90%, most preferably >95%, measured under 2 bar filtration pressure and 25° C.

Advantageously, porous hydrophilic polyimide membranes according to the invention may have both the above-mentioned properties.

Porous hydrophilic polyimide membranes according to the invention may be prepared using any suitable method known in the art for the preparation of porous polymer membranes. For example, the method of preparation may be selected from non-solvent induced phase separation (NIPS), vapor-induced phase separation (VIPS), electrospinning, track etching and sintering.

Preferably, hydrophilic polyimide membranes according to the invention may be prepared using non-solvent induced phase separation (NIPS). The NIPS method uses a ternary composition, usually including the polymer, a solvent and a non-solvent. The NIPS process (immersion precipitation) typically starts by mixing at least a polymer and a solvent to form an initial homogeneous solution. Then, the polymer solution is cast as a thin film on a support or extruded through a die to generate the membrane shapes such as flat sheets or hollow fibers.

Subsequently, the material goes into a coagulation bath containing a non-solvent or a poor solvent for the polymer, and hence, phase separation takes place when the solvent exchanges into the non-solvent and precipitation occurs in the polymeric solution.

As such, in still another aspect, the present invention provides a method of preparing a porous membrane comprising a hydrophilic polyimide according to the present invention, said method comprising:
(i) providing a polymer solution comprising a solvent and said hydrophilic polyimide;
(ii) casting the polymer solution as a thin film; and
(iii) subjecting the thin film to coagulation in deionized water.

Suitable components of casting solutions are known in the art, which may be used as desired. Illustrative solutions comprising polymers, and illustrative solvents and nonsolvents include those disclosed in, for example, U.S. Pat. Nos. 4,629,563; 4,900,449; 4,964,990, 5,444,097; 5,846,422; 5,906,742; 5,928,774; 6,045,899; and 7,208,200. [1-9]

The polymer solution used for casting the polyimide may contain the polyimide in the range of about 10 wt/v % to about 35 wt/v %. For example, 10 g, 15 g, 20 g, 25 g, 30 g or 35 g of polyimide in 100 mL of solvent may be used.

Advantageously, the solvent may be selected from any suitable organic solvent. For example, the solvent may be selected from N-methylpyrrolidone, dimethylformamide, dimethylacetamide, and mixtures of two or more thereof. The polyimide may be mixed with the solvent at a suitable temperature for a sufficient time to effect complete dissolution of the polymer in the solvent.

The polyimide solution may be cast as a thin film on a suitable support or extruded through a die to generate the membrane shapes such as flat sheets or hollow fibers.

Preferably, the polyimide solution may be applied to a suitable support, evenly to form a film of polyimide. Suitable supports include glass plates, polymeric supports, such as polymeric non-woven fabrics. For example polyethylene/polypropylene non-woven fabrics may be used as support.

The film may then be either placed in a chamber with controlled temperature, air velocity and humidity, or directly immersed into a water bath with a preset temperature, allowing some time for the polyimide to transform into a solid film. For example, the polyimide film cast on the support may be immersed in a water bath at ambient temperature (e.g., 20±5° C.). The resulting solid film sample may then be coagulated in deionized water at room temperature for a sufficient amount of time to remove the residual solvent, to afford a sheet of porous hydrophilic polyimide membrane.

Membrane thickness may range from 50 to 500 μm, for example 50-400 μm, for example 50-300 μm, for example 50-200 μm, for example about 100 μm.

Liquid Phase Separation

In yet another aspect, the present invention provides a liquid phase separation system comprising a porous hydrophilic polyimide membrane according to the invention, as described generally and in any variant herein.

Porous hydrophilic polyimide membrane according to the invention may find use as ultra-filtration membranes.

As such, in another aspect, the present invention also provides a liquid phase separation method comprising a step of selectively permeating proteins from an aqueous phase containing proteins, using the liquid phase separation system according to the invention, as described generally and in any variant herein. The aqueous phase containing proteins may be obtained from a biological sample, such as cell cultures or extracts thereof, biopsied material obtained from a mammal or extracts thereof; blood, saliva, urine, feces, semen, tears, or other body fluids or extracts thereof.

Porous membranes according to the invention can be used in a variety of applications, including, for example, diagnostic applications (including, for example, sample preparation and/or diagnostic lateral flow devices), filtering fluids for the pharmaceutical industry, filtering fluids for medical applications (including for home and/or for patient use, e.g., intravenous applications, also including, for example, filtering biological fluids such as blood (e.g., to remove leukocytes)), filtering antibody- and/or protein-containing fluids, filtering nucleic acid-containing fluids, cell detection (including in situ), cell harvesting, and/or filtering cell culture fluids.

Membranes according to embodiments of the inventions can be used in a variety of devices, including medical devices and products.

The ultra-filtration membranes according to the invention may be advantageously used for the separation of proteins with average molecular weight in the range of 5 to 100,000 kDa.

### EQUIVALENTS

The representative examples that follow are intended to help illustrate the invention, and are not intended to, nor should they be construed to, limit the scope of the invention. Indeed, various modifications of the invention and many further embodiments thereof, in addition to those shown and described herein, will become apparent to those skilled in the art from the full contents of this document, including the examples which follow and the references to the scientific and patent literature cited herein. It should further be appreciated that the contents of those cited references are incorporated herein by reference to help illustrate the state of the art.

The following examples contain important additional information, exemplification and guidance that can be adapted to the practice of this invention in its various embodiments and the equivalents thereof.

### EXEMPLIFICATION

The composite materials of this invention and processes for their preparation can be understood further by the examples that illustrate some of the processes by which these composite materials are prepared or used. It will be appreciated, however, that these examples do not limit the invention. Variations of the invention, now known or further developed, are considered to fall within the scope of the present invention as described herein and as hereinafter claimed.

Materials and Methods

1. Materials

4,4′-(Hexafluoroisopropylidene)diphthalic anhydride (6FDA), 3,3′,4,4′-benzophenone tetracarboxylic dianhydride (BTDA), 3,3′,4,4′-Diphenylsulfonetetracarboxylic dianhydride (DSDA), 3,5-Diaminobenzoic acid (DABA) and 3,7-Diamino-2,8-dimethyldibenzothiophene Sulfone (DDBT) were obtained from TCI. Jefamine® ED-600 was provided by Huntsman Co. N-methyl-2-pyrrolidone (NMP) and Quinoline were purchased from Sigma-Aldrich. All the chemicals were used as received without further purification.

2. Characterizations

The chemical structures of the polyimides were characterized by ¹H NMR and FT-IR. ¹H NMR spectra were measured on Bruker AVANCE III 500 NMR spectrometer at 23° C. CDCl₃ and DMSO-d₆ were used as a solvent, and the residual solvent peaks were used as an internal standard (¹H NMR: CDCl₃ 7.26 ppm, DMSO-d₆ 2.5 ppm). The IR spectrum was collected in a Fourier Transform Infrared spectrometer (FTIR, Shimadzu, IRTracer-100), equipped with an attenuated total reflectance (ATR) cell in the range of 4000-500 cm⁻¹. The crystalline structure of membranes was characterized using wide-angle X-ray diffraction (WAXD, Rigaku RINT, Japan) with rotating-anode Cu Kα X-ray generator operated at 200 mA and 40 kV. Thermo-gravimetric analysis (TGA, Rigaku Thermo plus EVO2, Japan) was used under a nitrogen atmosphere at a 10° C./min ramp rate to evaluate membrane. Mechanical property tests were performed on the surface of polymer membranes using a nanoindentation tester (ENT 2100, Elionix) equipped with a Berkovich three-sided pyramid diamond tip (radius of 100 nm) at the load of 50 mN. 20 points in a rectangular configuration were tested on each sample; the average elastic modulus and hardness were calculated by Oliver and Pharr's method using the measured values of three different membrane samples. The morphology of ultra-filtration membranes according to the invention was studied by a scanning electron microscope (FESEM, Hitachi S-4800, Japan). The water contact angles of the films were determined by a goniometer to assess their surface hydrophilicity. Water contact angle measurements were performed on the thin dense layer side of the membrane, while the bottom porous sublayer side of the membrane was supported by a non woven fabric. Sessile contact angle titrations were conducted more than five times for each film with 4 μL deionized (Dl) water drops in the air, and the averaged values were reported.

A dead-end stirred cell filtration system connected with an N2 gas cylinder was used to evaluate the filtration performance of membranes. All ultrafiltration experiments were carried out using a filtration test cell (Sterlitech HP4750, USA) with a volume capacity of 200 mL and a stirring speed of 400 rpm at 25±1° C. The active area of the membrane was 14.6 cm². 1 mg/mL lysozyme solution was prepared at room temperature by dissolving a pre-weighed amount of lysozyme powder in phosphate buffer with the pH value of 7.0. The feed and permeate solutions were analyzed using a total organic carbon analyzer (TOC-L Shimadzu, Japan) to calculate the protein concentration. The rejection rates (R) of the protein solution by the membranes were determined via the following equation:

$$R = ( 1 - \frac{T O {C}_{permeate}}{T O {C}_{f e e d}} ) \times 100 \% \qquad ( 1 )$$

where TOCₚₑᵣₘₑₐₜₑ and TOC_{feed} are the respective TOC concentrations in the filtrate and feed of the protein solution.

For the static protein adsorption measurements, 25 g of protein solution (1 g/L lysozyme) was added to the stirred cell; the thin dense layer side of the membrane surface was exposed to the protein solution at stirring rate of 500 rpm (such that the penetrants flow was from the dense layer to the porous sublayer). After 2 h, the protein solution was disposed and the membrane surface was rinsed two times with pure water while is shaking for 1 min. Water fluxes were tested before and after the adsorption test. The membrane-solute interactions were analyzed by calculating the relative water flux reduction as below:

$$R F R = ( 1 - \frac{{J}_{0} - {J}_{a d s}}{{J}_{0}} ) \times 100 \% \qquad ( 2 )$$

where RFR is the relative water flux reduction. Jₒ and J_{ads} are water fluxes before and after adsorption, respectively. To avoid the effects of membrane compaction, each membrane was firstly washed and compacted at 4 bar for 30 min. The transmembrane pressure was reduced to 2 bar for water flux measurement.

### Example 1—Synthesis of Copolyimides

The copolyimides were synthesized in a two-step polycondensation reaction between dianhydride (6FDA, BTDA, and DSDA) and diamines (DABA, DDBT and Jefamine® ED-600) with different ratios (50/50, 25/75 and 75/25) (Scheme 1).

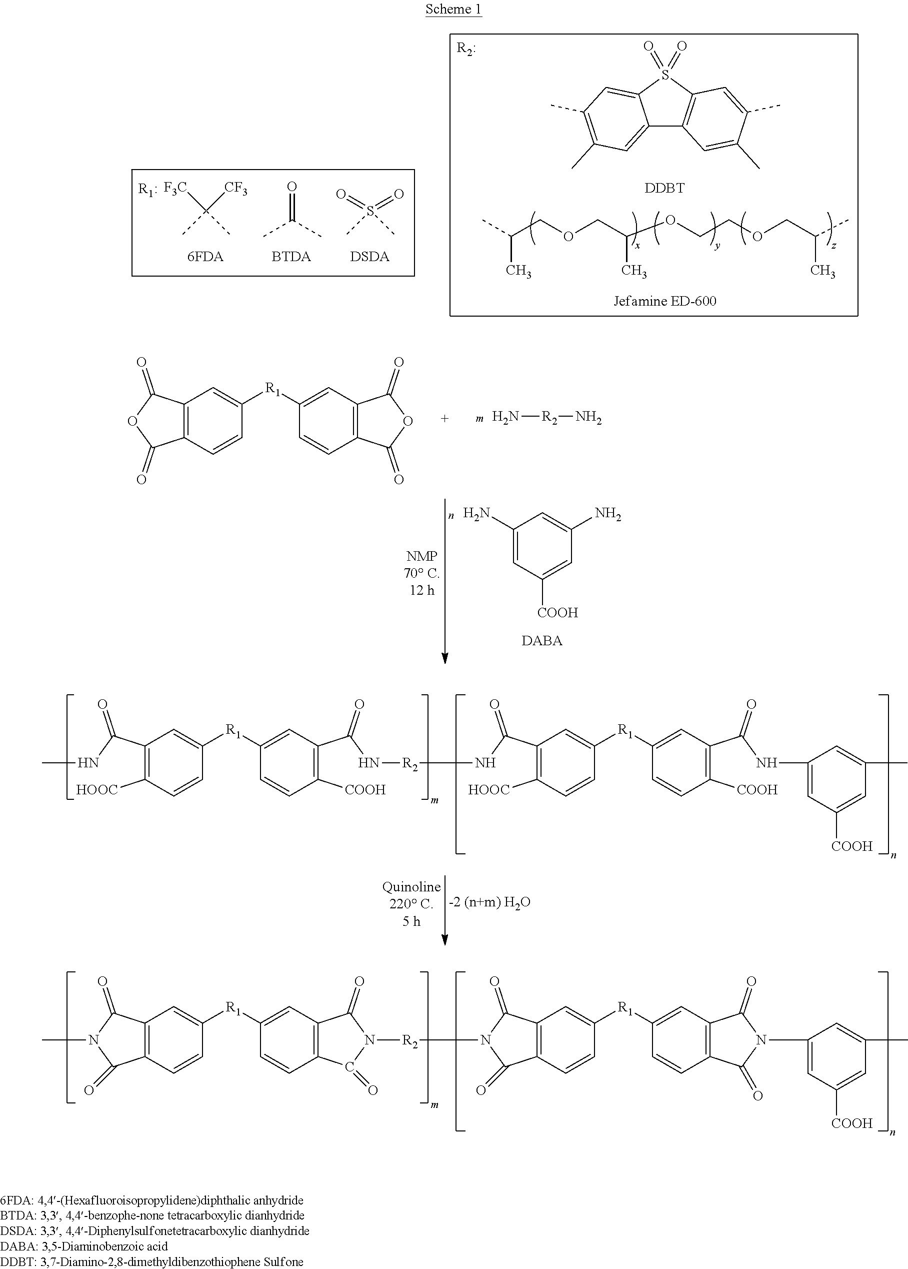

Solvothermal azeotropic cycloimidization reaction was performed using quinoline as catalyst at 220° C. under the nitrogen atmosphere. In order to enhance the hydrophilicity of the synthesized copolymers, DABA and PEG-based diamines (Jefamine ED-600) were used in different molar ratios, as shown in Table 2.

TABLE 2
Initial diamine ratios of the copolyimides and diamine
ratios determined by ¹H NMR spectroscopy.

| | | Diamine | Diamine ratio | | |
|---|---|---|---|---|---|
| | | ratio | measured by | Mw | |
| Name | Copolyimide composition | (m:n) | ¹H NMR | (g/mol) | PDI |
| S-PI-1 | 6FDA-DDBT/6FDA-DABA | 1:1 | 1.2:1 | 64,200 | 1.6 |
| S-PI-2 | 6FDA-DDBT/6FDA-DABA | 1:3 | 1:1.4 | 99,100 | 2.8 |
| S-PI-3 | 6FDA-DDBT/6FDA-DABA | 3:1 | 2.4:1 | 78,200 | 2.5 |
| S-PI-4 | BTDA-DDBT/BTDA-DABA | 1:1 | 1:0.8 | 66,300 | 1.8 |
| S-PI-5 | BTDA-DDBT/BTDA-DABA | 1:3 | 1:3.5 | 67,100 | 2.6 |
| S-PI-6 | BTDA-DDBT/BTDA-DABA | 3:1 | 2:1 | 82,000 | 2.2 |
| S-PI-7 | DSDA-DDBT/DSDA-DABA | 1:1 | 1:0.9 | 72,700 | 1.4 |
| S-PI-8 | DSDA-Jefamine ED-600/DSDA-DABA | 1:1 | | 58,400 | 1.6 |
| S-PI-9 | DSDA-Jefamine ED-600/DSDA-DABA | 1:3 | | 52,700 | 1.5 |
| S-PI-10 | 6FDA- Jefamine ED-600/6FDA-DABA | 1:1 | | 68,100 | 1.2 |

In Table 2, the reported MW and PDI were calculated using Gel Permeation Chromatography (“GPC”). PDI is equal to Mw/Mn, which can be derived from the retention time of the polymers passing through the Gel Permeation Chromatography column (ASTM D5296 and ISO 13885-1).

### Example 2—Membrane Preparation

Representative copolyimide membranes were prepared as follows: 24 g of the polymer prepared in Example 1 was dissolved in 100 mL NMP. The mixture was continuously stirred at 60° C. for 24 h to completely dissolve the polymer and obtain a transparent yellowish and homogeneous casting solution. After filtration and vacuum degassing, an appropriate amount of the solution was cast on a nonwoven fabric (PE/PP, Hirose Co. Japan) at ambient atmosphere. The wet thickness of the membranes was adjusted to 100 μm. After exposure to air for 30 seconds, the coated fabrics were immersed into a water bath. The obtained membrane was then coagulated in deionized water at room temperature and kept for 24 h to remove the residual NMP.

### Example 3—Characterization

1. Chemical Structure

The compositions of the copolyimides were confirmed by ¹H NMR spectral analysis. The integrals of the protons belonging to the diamines were in accordance with the desired composition of the structure. The ¹H NMR spectra are in agreement with the copolyimides structures reported herein, thereby confirming their structure. The real diamine ratio of the synthesized 6FDA copolyimides was determined by integrating the four aromatic protons of DDBT with the two ortho-substituted DABA-protons. For the BTDA and DSDA copolyimides, the actual diamine ratio was calculated by integrating and comparing the area of under the peak for the six protons of two methyl groups in DDBT with the two ortho-substituted DABA-protons [10]. Table 2 lists the expected diamine ratios of the synthesized (co)polyimides and those determined by ¹H NMR spectroscopy. (PEG-based samples).

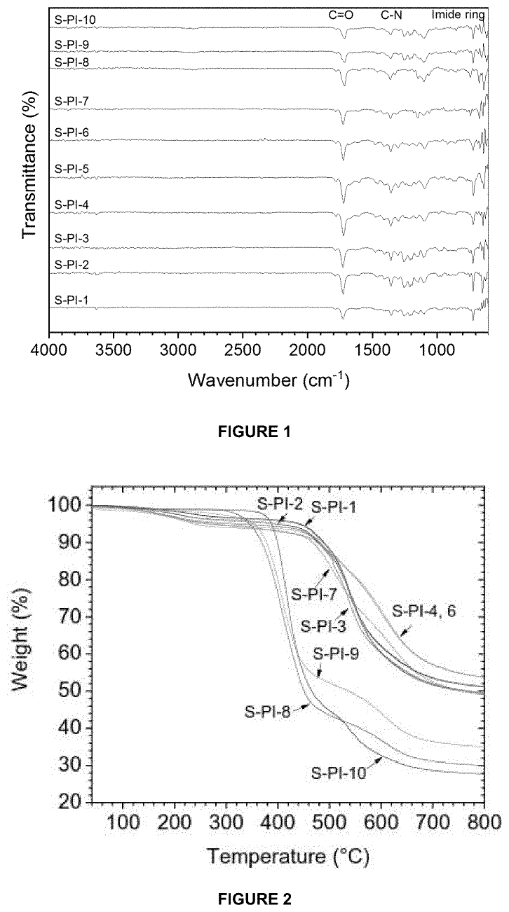

The structures of the synthesized copolyimides were further verified by FTIR spectroscopy (FIG. 1). All the synthesized polymers, exhibit typical characteristic bands of polyimides, i.e., the asymmetric C═O stretching at 1780 cm⁻¹, the symmetric C═O stretching at 1720 cm⁻¹, the C—N stretching at 1350 cm⁻¹, and the imide-five-ring deformation vibration and 720 cm⁻¹.

Moreover, the absence of bending vibrations of amide groups (C═O and N—H) at 1550 and 1650 cm⁻¹ indicates the completion of imidization reaction. The Mw and polydispersity index (PDI) of the synthesized polyimides varied between 50,000-100,000 g/mol and 1.2-2.8, respectively (Table 2), which are in the range of other reported polyimide structures. It was found that the presence of a second DABA monomer has a minimal effect on the molecular weight of copolyimides.

2. Thermal and X-Ray Analysis

The thermal stability of the synthesized copolyimides were studied using TGA. The synthesized copolyimides show relatively high thermal stability. The first step of decomposition in S-PI-1, 2, 3, 4 and 6 copolyimides starts at 460-480° C. (FIG. 2) which is due to the rigid and aromatic structure of these polyimides. The onset decomposition temperature of the Jefamine ED-600 based copolyimides is at 370-400° C. which is lower than that of other synthesized copolyimides. Without wishing to be bound to any particular theory, this behavior can be explained by the aliphatic nature of Jefamine ED-600. The presence of aliphatic blocks would enhance the flexibility of the polymer chain and provides less barrier to the molecular motion which facilitates the degradation process. It is reported that fully aliphatic polyimides degrade at about 250° C.

The synthesized copolyimides (containing both aromatic and aliphatic components) showed higher degradation temperature: the aromatic copolyimides retained more than 50% of their initial weight even at 800° C., indicating high thermal stability of the synthesized copolyimide structures.

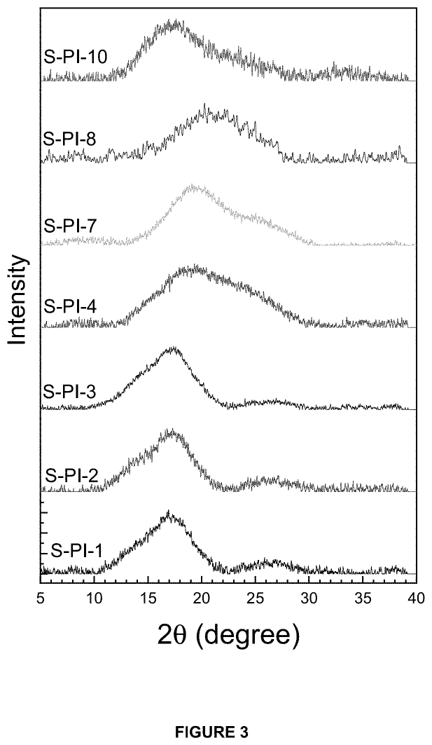

The microstructure of the copolyimides was investigated by wide angle X-ray diffraction (WAXD) analysis (FIG. 3). The synthesized copolyimides showed a broad amorphous peak between 17-20°. The d-spacing values of the polyimides calculated by Bragg's law (d=nλ/2 sin θ), was in the range of 5.2-4.4 Å, which is in the range of previously reported polyimide structures. The d-spacing values did not significantly change with the DABA content which is indicative of the absence of internal hydrogen bonding between the pendant carboxylic acid of the DABA and the functional groups in the polyimide's backbone.

3. Morphology

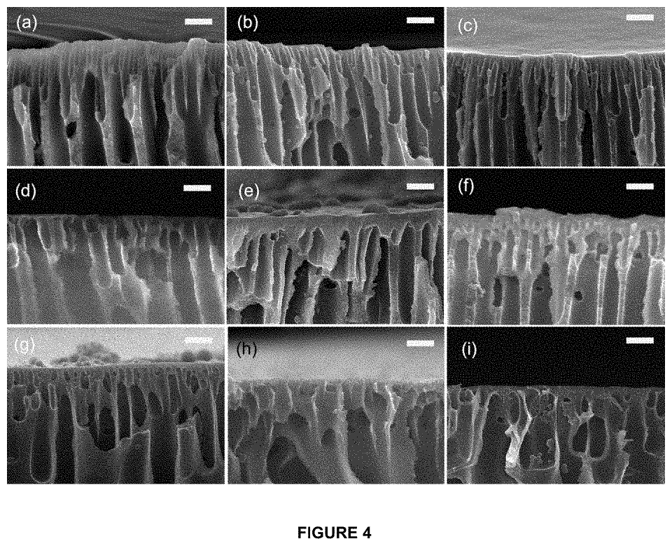

Cross-section SEM images were used to analysis of changes in the morphology of the polyimide membranes with different chemical structures (FIG. 4). The membranes show typical asymmetric structures, which consist of the thin dense skin layer and the porous sub-layer. The morphology of the UF membranes is generally highly influenced by its formation mechanism. Specifically, the chemical structure of the polyimides and their affinity to the organic solvent and coagulation medium typically affect the thermodynamics and kinetics of the phase inversion and consequently influence the microstructure of the membranes. The cross-section of S-PI1, 2 and 3 showed similar morphology with the longer finger-like voids in the membrane with higher DABA content (FIG. 4 (b)). Enlargement of the cavities might be due to water inflow into the hydrophilic polymer dope during the membrane formation. Without wishing to be bound by any particular theory, the more non-uniform structures with increasing size of finger-like cavities in Jefamine based samples (S-PI-8, 9), which can be seen in FIG. 4 (g)-(i), can be explained by enhanced demixing as a result of increased hydrophilicity. The higher thickness of the skin layer in S-PI-6 compared with that of the S-PI-7 is related to the higher viscosity of the dope solution in this membrane. The S-PI-10 membrane demonstrated low porosity because of the hydrophobic nature of the polymer, which is arising from the presence of 6FDA in the copolymer backbone.

In general, a highly porous sublayer with many finger-like microvoids, thin skin layer was formed during the precipitation process in more hydrophilic polyimides. The results indicate that the introduction of the sulfone (SO₂), and polyethylene ether (PEG) groups has a more significant effect on the membrane structure than increasing the DABA content with carboxylic functionality.

4. Water Contact Angle Measurement

Surface hydrophilicity is one of the most important factors for determining antifouling property and performance of the ultrafiltration membrane.

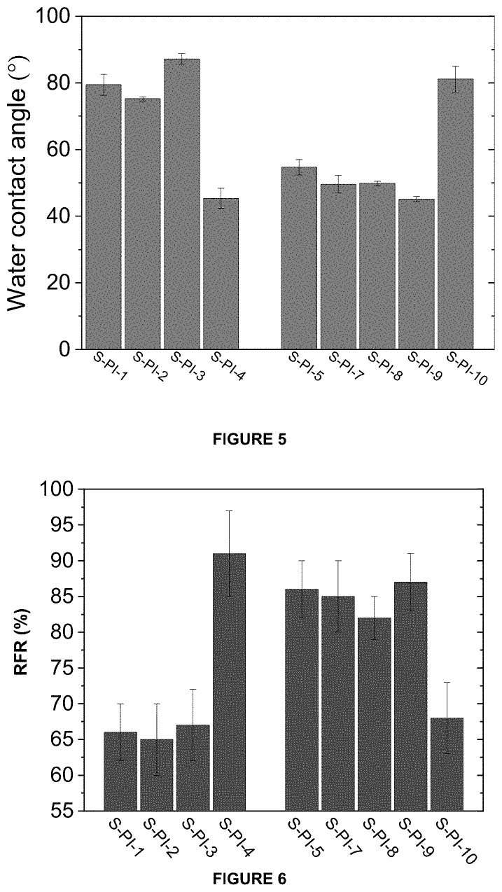

The hydrophilicity and wettability of the S-PI membranes were evaluated by contact angle measurement. It is generally accepted that the lower contact angle represents a greater tendency of water for wetting the membrane surface and higher hydrophilicity. Water contact angle measurements on different S-PIs membranes are presented in FIG. 5. As can be seen, the contact angle value of the membranes was highly dependent on the hydrophilic content of copolymer structure. For example, there is a significant decrease in the water contact angle of BTDA-based copolymers (S-PI-4 and 6) compared with the copolyimides with 6FDA in the backbone (S-PI-1-3 and S-PI-10).

Also, the contact angle values decreased significantly (about 50°) by adding the sulfone group in the polymer backbone. S-PI-8 and S-PI-9 showed the highest hydrophilicity with contact angle about 45° among the other structures. The presence of PEG moieties in the copolyimide skeleton can form a hydration layer on the surface of membranes via the electrostatic interaction in addition to the hydrogen bond which improves the hydrophilicity of the copolymers.

5. Protein Adsorption

The static protein adsorption is one of the important factors determining the membrane fouling property. The lysozyme was used as the model protein to evaluate the static protein adsorption on the surface of the hydrophilic PI membranes. The antifouling property of membranes is generally highly dependent on the membrane surface, such as surface charge character, free energy, chemical composition, and morphology. The protein adsorption on a hydrophobic membrane surface can accelerate the membrane fouling. Therefore, the increment in the surface hydrophilicity is generally considered as an effective method to enhance the antifouling property of a membrane. As is shown in FIG. 6, the hydrophilic S-PIs membrane exhibited lower adsorption, which can be attributed to the introduction of the hydrophilic sulfonic acid groups. Interestingly, this order is very similar to the trend found in the static water contact angle measurement. The protein resistant chemical structures are generally hydrophilic electrically neutral hydrogen-bond acceptors. The S-PI-4-9 copolyimides including sulfonic acid groups, share all of these common characteristics. It is commonly believed that hydrogen bond can create hydration layer on the surface of membranes. Consequently, the protein is excluded from the hydration layer to avoid the entropy loss caused by the entrance of large protein molecules into the porous layer.

6. Filtration Performance

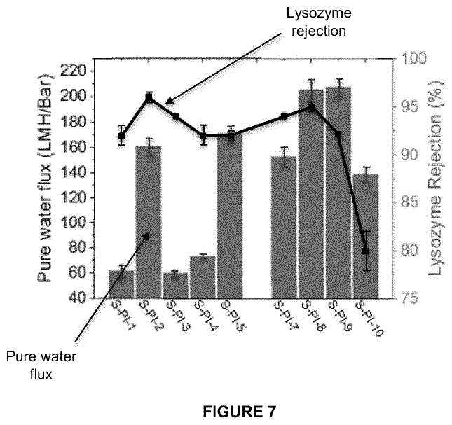

The pure water flux and the protein rejection of the prepared membranes were tested at 2 bar and 25° C., and the results are shown in FIG. 7 (the thin dense layer side of the membrane surface (i.e., the functional selective barrier of the membrane) was exposed to the protein solution, such that the penetrants flow was from the dense layer to the porous sublayer). It can be seen that the water flux of the membranes increased with an increasing polar group (SO₂, COOH and PEG), which could be attributed to the larger driving force provided by the hydrogen bonds between SO₂, COOH and PEG groups and water molecules. During the casting process, the hydrophilic blocks of polyimide copolymers would potentially be oriented to the interface between the casting solution and the water bath. The hydrophilic surface of the polyimides would facilitate the adsorption and passage of the water molecules from the surface to the pores. In addition, as observed in SEM images (FIG. 4), an increase in the content of hydrophilic groups in the polymer backbone would create larger finger-like structures and more pores on the bottom surfaces of membranes. The water flux of S-PI membranes depended on the monomer type and its concentration of polar group. For example, for 6FDA based copolyimides (S-PI-1, 2 and 3), the presence of an additional ratio of carboxylic group in S-PI-2 increased the water flux from about 60 to 160 LMH/Bar. Also, the more hydrophilic PEG-based copolymers such as S-PI-8 and 9 showed the high water flux up to 205 LMH/Bar. This could be related to the combination of the improved hydrophilicity, porosity and surface roughness of membranes in this series. Nonetheless, the S-PI-10 is also including the PEG moiety in the structure, its water flux is substantially lower than the ones of S-PI-8 and 9. This could be explained by the lower contact angle value of this membrane. Moreover, the BTDA based membranes showed a significant change in the water flux by adding more DABA content in the chemical structure. The water flux of S-PI-5 reached 170 LMH/Bar which is more than twice that of the S-PI-4 membrane. However, the DSDA polyimide membrane (S-PI-7) exhibited water flux of around 150 LMH/Bar. These results indicate that the separation performance of polyimide membranes could be optimized using the right combination of monomers with polar moieties. The protein rejection performance of the prepared membranes was measured by filtering the 1 g/L lysozyme solution through the ultra-filtration membranes of the invention. Except for S-PI-10, all the copolyimide membranes with sulfone functionality showed high rejections (more than 90%) of the lysozyme (Mw. 14,000 g/mol) which make them appealing candidates as 10 kDa molecular weight cut off (MWCO) membranes. Generally, the sulfonated PI membranes showed higher protein rejection compared to the typical PI membranes (FIG. 7), which is likely due to the following two reasons. Firstly, the surfaces of the synthesized PI membranes in this work is more hydrophilic because of the existence of polar functional groups such as —SO₂, —COOH, and PEG. Without wishing to be bound to any particular theory, it is proposed that the interaction between those polar groups and the water molecules would lead to higher adsorption of water molecules on the membrane surface which forms a thin hydration layer between the foulants and the membrane surfaces. This hydration layer is not only increasing the permeability of the membranes but also impede the contact between lysozyme and the membrane surfaces. Secondly, both lysozyme and the surface of S-PIs membranes are negatively charged due to the existence of polar moieties. The electrostatic repulsion between these negatively charged surfaces also prevents the attachment of lysozyme to the membrane surface and result in a high protein rejection value. S-PI-8 membrane which is made from the combination of DSDA, PEG, and carboxylic acid has the best separation performance with high lysozyme rejection of 96% and water flux of about 205 LMH/Bar. This result inferred that trends of protein rejection strongly depends on the chemistry of membranes. The “resent Examples reveal that to design functional hydrophilic membrane and to improve the protein rejection and water flux across the membrane, the combination of monomer and their polar group ratios are highly important factors. This is precisely what has been accomplished by the present invention.

### CONCLUSION

For the first time, hydrophilic sulfur-containing copolyimides have been developed for ultrafiltration membrane applications. These copolyimides, which were synthesized from a combination of different monomers with hydrophilic properties, show excellent solubility and hydrophilicity are attractive materials for membrane separation applications.

The precise control of the ratio of monomers such as SO₂, COOH, PEG in a direct copolymerization reaction was effected using a various combination of monomers with different chemistry and functionality, thereby providing a platform to develop membranes with superior separation performance and antifouling properties. Among the copolyimides illustrated herein in the Examples, the optimum copolymer structure can achieve high water flux (>200 LMH/Bar), and protein rejection (>95%). The chemical structure was confirmed by FT-IR and ¹H NMR measurements. The static water contact angle test confirmed the enhanced hydrophilicity of the hydrophilic polyimide membranes according to the invention.

The polyimide membranes of the invention exhibited noticeably larger permeation fluxes during both water and lysozyme solution filtration than the conventional polyimide membranes.

All references throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

All patents and publications mentioned in the specification are indicative of the levels of skill of those skilled in the art to which the invention pertains. References cited herein are incorporated by reference herein in their entirety to indicate the state of the art, in some cases as of their filing date, and it is intended that this information can be employed herein, if needed, to exclude (for example, to disclaim) specific embodiments that are in the prior art. For example, when a compound is claimed, it should be understood that compounds known in the prior art, including certain compounds disclosed in the references disclosed herein (particularly in referenced patent documents), are not intended to be included in the claim.

### LIST OF REFERENCES

[1] U.S. Pat. No. 4,629,563;
[2] U.S. Pat. No. 4,900,449;
[3] U.S. Pat. No. 4,964,990,
[4] U.S. Pat. No. 5,444,097;
[5] U.S. Pat. No. 5,846,422;
[6] U.S. Pat. No. 5,906,742;
[7] U.S. Pat. No. 5,928,774;
[8] U.S. Pat. No. 6,045,899;
[9] U.S. Pat. No. 7,208,200
[10] X. Pei, G. Chen, Y. Hou, X. Fang, Comparative study on polyimides derived from isomeric diphenylsulfonetetracarboxylic dianhydrides, High Performance Polymers, 25 (2012) 312-323.

We claim:

1. A hydrophilic polyimide including at least one type of building blocks [A-B] and [A-C], and represented by the formula -[A-B]ₙ-[A-C]ₘ— (I), wherein:
the n-bracketed building blocks and the m-bracketed building blocks are randomly distributed over the polyimide chain;
repeat unit A results from a monomer comprising two carboxylic anhydride moieties,
repeat unit B is hydrophilic and results from a first hydrophilic monomer comprising two primary amine moieties and at least one further hydrophilic moiety different from the primary amines, and
repeat unit C is hydrophilic and results from a second hydrophilic monomer comprising two primary amine moieties and at least one further hydrophilic moiety different from the primary amines;
wherein:
n and m represent independently an integer from 0 to about 1000; and
wherein n+m is an integer from about 10 to about 1000.

2. The hydrophilic polyimide of claim 1, wherein:
(a) the monomer comprising two carboxylic anhydride moieties has the structure (III): 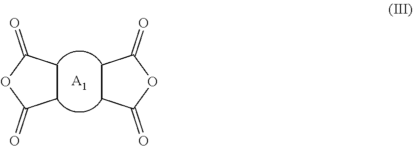
wherein A₁ represents a cyclic or acyclic moiety linking both carboxylic anhydride groups;
(b) the first hydrophilic monomer has the structure (IV): 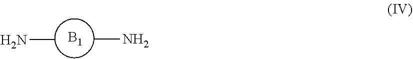
wherein B₁ represents an aliphatic, alicyclic, heteroaliphatic, heterocyclic, aromatic or heteroaromatic moiety, bearing at least one hydrophilic monovalent or divalent group selected from —C(═O)OH, —OH, —OR, —NO₂, —SH, —SO₂H, —SO₂R, —SO₂—, or an ether moiety —CX—O—R, wherein X represents a monovalent substituent, and each occurrence of R independently represents C1-6alkyl or C6-10aryl;
(c) the second hydrophilic monomer has the structure (V): 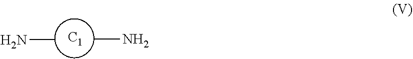
wherein C₁ represents an aliphatic, alicyclic, heteroaliphatic, heterocyclic, aromatic, heteroaromatic moiety; bearing at least one hydrophilic di-valent group selected from —SO₂—, —NR^{C1}—, —NR^{C1}—CX—NR^{C1}—, —S—, or —S—S—; or else C₁ represents a polyethylene oxide moiety;
wherein X represents a monovalent substituent, and each occurrence of R^{C1} independently represents H or C1-6alkyl.

3. The hydrophilic polyimide of claim 2, wherein:
(a) the monomer comprising two carboxylic anhydride moieties has the structure (VI): 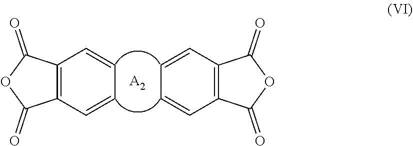
wherein A₂ represents a cyclic or acyclic moiety linking both benzene carboxylic anhydride groups; including the structure (VII): 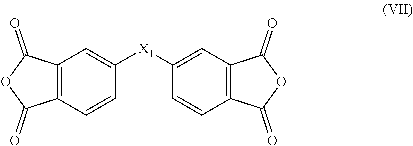
wherein X₁ represents C═0, SO₂, —O— or C(CF₃)₂;
(b) the first hydrophilic monomer comprising two primary amine moieties has the structure (VIII): 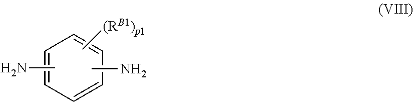
wherein
p1 represents 1 or 2;
each occurrence of R^{B1} independently comprises or represents a hydrophilic monovalent or divalent group selected from —C(═O)OH, —OH, —OR, —NO₂, —SH, —SO₂H, —SO₂R, —SO₂—, or an ether moiety —CX—O—R, wherein X represents a monovalent substituent, and each occurrence of R independently represents C1-6alkyl or C6-10aryl;
including the structure (IX): 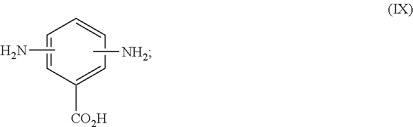
(c) the second hydrophilic monomer comprising two primary amine moieties has the structure (X): 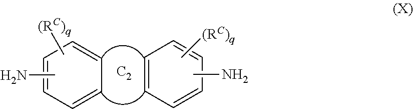
wherein
C₂ represents a cyclic or acyclic moiety linking the two phenyl groups, bearing at least one hydrophilic di-valent group selected from —SO₂—, —NR^{C1}—, —NR^{C1}—CW—NR^{C1}—, —S—, or —S—S—; wherein each occurrence of R^{C1} independently represents H or C1-6alkyl; and W represents a monovalent substituent;
each occurrence of R^{C} independently represents H or C1-6alkyl; and
each occurrence of q independently represents 0, 1 or 2;
including the structure (XI): 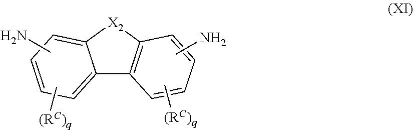
wherein
X₂ represents —SO₂—;
each occurrence of R^{C} independently represents H or C1-6alkyl; and
each occurrence of q independently represents 0, 1 or 2;
or the second hydrophilic monomer comprising two primary amine moieties is a diamino-functionalized polyethylene oxide of the structure (XII):
H₂N—PEO—NH₂ (XII)
wherein PEO represents a polyether chain, including polyethylene oxide or polyethylene glycol, of molecular weight from 200 to 10,000 g/mol.

4. The hydrophilic polyimide of claim 1, of formula -[A-B]ₙ-[A-C]ₘ— (I), wherein the molar ratio of repeat units B and C are each independently from 10-90%, and the molar ratio of repeat units A equals the sum of the molar ratio B+C.

5. The hydrophilic polyimide of claim 1, including at least one type of building blocks [A-B] and [A-C], wherein the polyimide is represented by the formula: 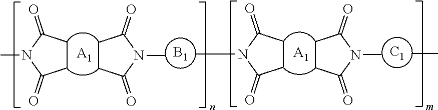
wherein the n-bracketed building blocks and the m-bracketed building blocks are randomly distributed over the polyimide chain;
n and m represent independently an integer from 0 to about 1000; wherein n+m is an integer from about 10 to about 1000; and
A₁ represents a cyclic or acyclic aliphatic, heteroaliphatic, aromatic or heteroaromatic moiety linking both carboxylic anhydride groups;
B₁ represents an aliphatic, alicyclic, heteroaliphatic, heterocyclic, aromatic or heteroaromatic moiety, further bearing at least one hydrophilic monovalent or divalent group selected from —C(═O)OH, —OH, —OR, —NO₂, —SH, —SO₂H, —SO₂R, —SO₂—, or an ether moiety —CX—O—R, wherein X represents a monovalent substituent, and each occurrence of R independently represents C1-6alkyl or C6-10aryl; and
C1 represents an aliphatic, alicyclic, heteroaliphatic, heterocyclic, aromatic, heteroaromatic moiety; bearing at least one hydrophilic di-valent group selected from —SO₂—, —NR^{C1}—, —NR^{C1}—CW—NR^{C1}—, —S—, or —S—S—; or else C₁ represents a polyethylene oxide moiety; wherein W represents a monovalent substituent, and each occurrence of R^{C1} independently represents H or C1-6alkyl.

6. The hydrophilic polyimide of claim 1 or 5, having a surface hydrophilicity characterized by a contact angle <90° measured by the static sessile water drop method with 1-10 μL deionized water drops at ambient air conditions.

7. A method of preparing a hydrophilic polyimide of claim 1, comprising:
(i) providing:
a monomer A comprising two carboxylic anhydride moieties;
a first hydrophilic monomer B comprising two primary amine moieties and at least one further hydrophilic moiety different from the primary amines; and
optionally a second hydrophilic monomer C comprising two primary amine moieties and at least one further hydrophilic moiety different from the primary amines; wherein the molar ratio A/(B+C) is about 1; and
(ii) carrying out cycloimidization polymerization of the first hydrophilic monomer, and optionally the second hydrophilic monomer, with the monomer comprising two carboxylic anhydride moieties.

8. The method of claim 7, wherein:
(a) the monomer A comprising two carboxylic anhydride moieties has the structure (III): 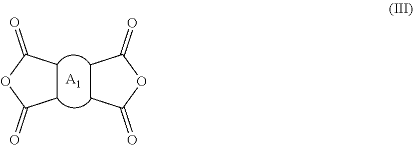
wherein A₁ represents a cyclic or acyclic moiety linking both carboxylic anhydride groups;
(b) the first hydrophilic monomer B has the structure (IV): 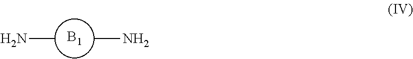
wherein B₁ represents an aliphatic, alicyclic, heteroaliphatic, heterocyclic, aromatic or heteroaromatic moiety, bearing at least one hydrophilic monovalent or divalent group selected from —C(═O)OH, —OH, —OR, —NO₂, —SH, —SO₂H, —SO₂R, —SO₂—, or an ether moiety —CX—O—R, wherein X represents a monovalent substituent, and each occurrence of R independently represents C1-6alkyl or C6-10aryl; and
(c) the optional second hydrophilic monomer C has the structure (V): 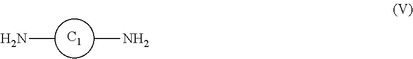
wherein C₁ represents an aliphatic, alicyclic, heteroaliphatic, heterocyclic, aromatic, heteroaromatic moiety; bearing at least one hydrophilic di-valent group selected from —SO₂—, —NR^{C1}—, —NR^{C1}—CX—NR^{C1}—, —S—, or —S—S—;
or else C1 represents a polyethylene oxide moiety;
wherein X represents a monovalent substituent, and each occurrence of R^{C1} independently represents H or C1-6alkyl.

9. The method of claim 8, wherein:
(a) the monomer comprising two carboxylic anhydride moieties has the structure (VI): 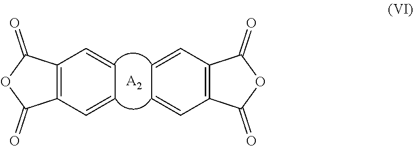
wherein A₂ represents a cyclic or acyclic moiety linking both benzene carboxylic anhydride groups; including the structure (VII): 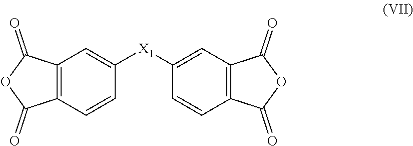
wherein X₁ represents C═O, SO₂, —O— or C(CF₃)₂;
(b) the first hydrophilic monomer comprising two primary amine moieties has the structure (VIII): 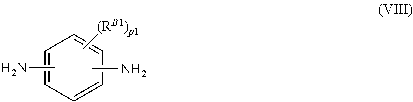
wherein
p1 represents 1 or 2;
each occurrence of R^{B1} independently comprises or represents a hydrophilic monovalent or divalent group selected from —C(═O)OH, —OH, —OR, —NO₂, —SH, —SO₂H, —SO₂R, —SO₂—, or an ether moiety —CX—O—R, wherein X represents a monovalent substituent, and each occurrence of R independently represents C1-6alkyl or C6-10aryl;
including the structure (IX): 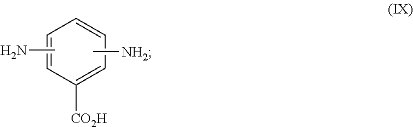
(c) the second hydrophilic monomer comprising two primary amine moieties has the structure (X): 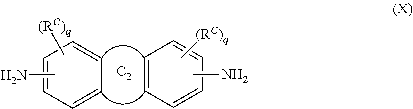
wherein
C₂ represents a cyclic or acyclic moiety linking the two phenyl groups, bearing at least one hydrophilic di-valent group selected from —SO₂—, —NR^{C1}—, NR^{C1}—CW—NR^{C1}, —S—, or —S—S—; wherein each occurrence of R^{C1} independently represents H or C1-6alkyl; and W represents a monovalent substituent;
each occurrence of R^{C} independently represents H or C1-6alkyl; and
each occurrence of q independently represents 0, 1 or 2;
including the structure (XI): 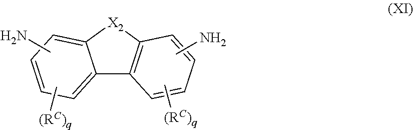
wherein
X₂ represents —SO₂—;
each occurrence of R^{C} independently represents H or C1-6alkyl; and
each occurrence of q independently represents 0, 1 or 2:
or the second hydrophilic monomer comprising two primary amine moieties is a diamino-functionalized polyethylene oxide of the structure (XII):
H₂N—PEO—NH₂ (XII)
wherein PEO represents a polyether chain, including polyethylene oxide or polyethylene glycol, of molecular weight from 200 to 10,000 g/mol.

10. The method of claim 7, wherein the molar ratio B/C is about 1.

11. A porous membrane comprising a hydrophilic polyimide of claim 1.

12. The porous membrane of claim 11, having:
a pure water flux >60 L/h/m²/bar, preferably >100 L/h/m²/bar, most preferably >200 L/h/m²/bar, measured under 2 bar filtration pressure and 25° C.; and
a lysozyme rejection >80%, preferably >85%, more preferably >90%, most preferably >95%, measured under 2 bar filtration pressure and 25° C.

13. The porous membrane of claim 11, wherein the membrane has a typical asymmetric structure which consists of a thin dense layer and a porous sub-layer.

14. A method of preparing a porous membrane comprising a hydrophilic polyimide of claim 1, said method comprising:
(i) providing a polymer solution comprising a solvent and said hydrophilic polyimide;
(ii) casting the polymer solution as a thin film; and
(iii) subjecting the thin film to coagulation in deionized water.

15. A method of claim 14, wherein the solvent is selected from N-methylpyrrolidone, Dimethylformamide, Dimethylacetamide, and mixtures of two or more thereof.

16. A liquid phase separation system comprising the porous membrane of claim 11, 12 or 13.

17. A liquid phase separation method comprising a step of selectively permeating proteins from an aqueous phase containing proteins, using the liquid phase separation system of claim 16.
